(19) United States
(12) Patent Application Publication
(10) Pub. No.: US 2023/0331033 A1
(43) Pub. Date: Oct. 19, 2023

(54) DECORATIVE SHEET, DECORATIVE MATERIAL, PLATE, AND METHOD OF MANUFACTURING DECORATIVE SHEET

(71) Applicant: Dai Nippon Printing Co., Ltd., Tokyo (JP)

(72) Inventors: Hironaga Usui, Tokyo (JP); Shinji Iwata, Tokyo (JP); Keisuke Tsuruta, Tokyo (JP)

(73) Assignee: Dai Nippon Printing Co., Ltd., Tokyo (JP)

(21) Appl. No.: 18/028,870

(22) PCT Filed: Aug. 31, 2021
(86) PCT No.: PCT/JP2021/031959

§ 371 Date: Mar. 28, 2023

(30) Foreign Application Priority Data
Sep. 28, 2020 (JP) 2020-162001
Aug. 27, 2021 (JP) 2021-139318

(51) Int. Cl. B44F 9/02; B44C 3/02

(52) U.S. Cl. CPC B44F 9/02; B44C 3/02

(57) ABSTRACT

A decorative material includes recesses and protrusions on a surface thereof, and includes recessed portions that are linear and that extend in a meandering manner in planar view. A plurality of the recessed portions that are adjacent in planar view come into contact, and a plurality of protruding portions are formed that are surrounded by the adjacent recessed portions. A layout of the plurality of protruding portions is irregular.

### TECHNICAL FIELD

The present invention relates to a decorative sheet, a decorative material, a plate, and a method of manufacturing the decorative sheet.

### BACKGROUND ART

Decorative materials are used to impart design quality to surfaces of building materials, furniture, home electric appliances, interior materials for vehicles, and so forth. Decorative materials include decorative sheets, in order to increase design quality. Decorative sheets have a design layer that expresses a design. A decorative sheet described in Patent Document 1 has a wood-grain pattern as a printed pattern. Patent Document 2 to Patent Document 5 propose forming recesses and protrusions on the surface of decorative sheets and imparting tactile sensation (or tactile impression), in order to further increase the design quality of the decorative sheet.

Patent Document 6 discloses a decorative sheet that expresses the surface of a wood material. The decorative sheet described in Patent Document 6 includes a motif pattern layer 3 having a wood-grain pattern, and raised portions provided only on part of a region of the motif pattern layer 3. In Patent Document 6, the raised portions are disposed in accordance with a motif of the motif pattern layer 3. The raised portions can impart more excellent design quality to the decorative sheet through a tactile sensation in accordance with the pattern of the motif pattern layer 3.
Patent Document 1: JPH10-312052A
Patent Document 2: JP2018-114711A
Patent Document 3: JP2020-44817A
Patent Document 4: JP2008-87155A
Patent Document 5: WO2019/194202
Patent Document 6: JP2018-167435A

In a conventional decorative sheet, the raised portions are formed by high-coating-volume printing using gravure plates. Regions of the gravure plates corresponding to the raised portions have a great number of cells, serving as depressions that have predetermined shapes, provided in an orderly manner (see FIG. 22). The cells accommodate ink, and the ink in the cells is transferred to the decorative sheet. The raised portions are collections of protruding portions made up of the transferred ink.

When the distance between adjacent cells is sufficiently long, the distance between the protruding portions is sufficiently secured. According to this decorative sheet, not only is tactile sensation obtained by edges of the raised portions, but tactile sensation is also obtained due to the protruding portions. Accordingly, the design quality of the decorative sheet can be improved through tactile sensation. On the other hand, when intervals between the protruding portions become large, the orderly layout of the protruding portions is visually recognized. This gives an impression of artificialness. As a result, the design quality of the decorative sheet cannot be sufficiently improved. Conversely, in a case in which the intervals between the protruding portions are small, the orderly layout of the protruding portions is not readily visually recognized. However, the protruding portions become tightly packed and form a large flat portion. Accordingly, tactile sensation among the protruding portions is not obtained, and the design quality of the decorative sheet through tactile sensation cannot be improved. That is to say, both excellent tactile sensation and natural features cannot be realized with the conventional art.

### SUMMARY OF THE INVENTION

It is an object of the present disclosure to impart both excellent tactile sensation and natural features to decorative sheets.

According to an embodiment of the present disclosure, a decorative sheet includes
a design layer that includes a pattern of a surface of wood, and
a raised layer that is stacked to the design layer, wherein
the raised layer includes a raised portion provided in a raised region that is overlaid to part of the design layer, and
the raised portion includes an uneven surface like the surface of wood.

According to an embodiment of the present disclosure, a decorative sheet includes
a design layer that includes a pattern of a surface of wood, and
a raised layer that is stacked to the design layer, wherein
the raised layer includes a raised portion provided in a raised region that is overlaid to part of the design layer, and
the raised portion includes an uneven surface that is irregular.

According to an embodiment of the present disclosure, a decorative sheet includes
a design layer that includes a pattern of a surface of wood, and
a raised layer that is stacked to the design layer, wherein
the raised layer includes a raised portion provided in a raised region that is overlaid to part of the design layer,
the raised portion includes an uneven surface that includes protruding portions and recessed portions, and
at least one of the protruding portions and the recessed portions include linear portions of which at least one of orientations and lengths are not constant.

According to an embodiment of the present disclosure, a plate is
a plate used in forming a raised layer of a decorative sheet, the plate including
a plate surface including a plate flat surface that is flat and a plate uneven surface that includes recesses and protrusions, wherein
the plate uneven surface includes depressions, and banks including flat surfaces that are positioned between the depressions, and
at least one of the depressions and the banks include linear elements of which at least one of orientations and lengths are not constant.

According to an embodiment of the present disclosure, a plate is
a plate used in forming a raised layer of a decorative sheet, the plate including
a plate surface including a plate flat surface that is flat and a plate uneven surface that includes recesses and protrusions that are irregular, wherein
the plate uneven surface includes depressions, and banks including flat surfaces that are positioned between the depressions.

According to an embodiment of the present disclosure, a method of manufacturing a decorative sheet includes
forming a design layer, and
forming a raised portion using the plate described above, thereby forming a raised layer including the raised portion, wherein
the raised portion is positioned in a raised region that is overlaid to part of the design layer.

According to an embodiment of the present disclosure, a decorative sheet is a decorative sheet that includes recesses and protrusions on a surface thereof, and includes recessed portions that are linear and also extend in a meandering manner in planar view, and, in planar view, protruding portions are formed that are surrounded by adjacent recessed portions that come into contact, wherein a layout of the protruding portions is irregular.

According to the decorative sheet of the present disclosure, both excellent tactile sensation and natural features can be imparted to decorative sheets.

### BRIEF DESCRIPTION OF DRAWINGS

FIG. 1 is a diagram for describing an embodiment, and is a planar view illustrating an example of a decorative sheet and a decorative material.

FIG. 2 is a planar view illustrating a raised layer that can be included in the decorative sheet in FIG. 1.

FIG. 3 is a planar view illustrating an example of raised portions that can be included in the raised layer in FIG. 2.

FIG. 4 is a diagram corresponding to FIG. 3, and is a planar view schematically illustrating another example of raised portions.

FIG. 5 is a diagram corresponding to FIG. 3, and is a planar view schematically illustrating yet another example of raised portions.

FIG. 6 is a diagram corresponding to FIG. 3, and is a planar view schematically illustrating yet another example of raised portions.

FIG. 7 is a diagram corresponding to FIG. 3, and is a planar view schematically illustrating yet another example of raised portions.

FIG. 8 is a diagram corresponding to FIG. 3, and is a planar view schematically illustrating yet another example of raised portions.

FIG. 9 is a diagram corresponding to FIG. 3, and is a planar view schematically illustrating yet another example of raised portions.

FIG. 10 is a perspective view for describing an example of a layer configuration of the decorative material and the decorative sheet in FIG. 1, illustrating the decorative material and the decorative sheet at the raised portions.

FIG. 11 is a diagram corresponding to FIG. 10, and is a perspective view for describing another example of the layer configuration of the decorative material and the decorative sheet.

FIG. 12 is a diagram corresponding to FIG. 10, and is a perspective view for describing yet another example of the layer configuration of the decorative material and the decorative sheet.

FIG. 13 is a diagram corresponding to FIG. 10, and is a perspective view for describing yet another example of the layer configuration of the decorative material and the decorative sheet.

FIG. 14 is a diagram for describing an example of a method of manufacturing the raised layer.

FIG. 15 is a developed planar view illustrating an example of a plate surface of a plate used in manufacturing the raised layer.

FIG. 16 is a diagram corresponding to FIG. 15, and is a developed planar view illustrating another example of the plate surface.

FIG. 17 is a diagram corresponding to FIG. 15, and is a developed planar view illustrating yet another example of the plate surface.

FIG. 18 is a diagram corresponding to FIG. 15, and is a developed planar view illustrating yet another example of the plate surface.

FIG. 19 is a diagram corresponding to FIG. 15, and is a developed planar view illustrating yet another example of the plate surface.

FIG. 20 is a diagram corresponding to FIG. 15, and is a developed planar view illustrating yet another example of the plate surface.

FIG. 21 is a perspective view describing a method of manufacturing the plate illustrated in FIG. 15 to FIG. 20.

FIG. 22 is a planar view illustrating a plate surface of a plate used for fabricating a conventional raised layer.

### DETAILED DESCRIPTION OF THE INVENTION

An embodiment will be described below with reference to specific examples illustrated in the drawings. The present disclosure is not limited to the embodiments described below. Sizes and ratios in the illustrated examples may be changed or exaggerated for the sake of ease of understanding. Illustration and signs of part of components may be omitted, in order to facilitate viewing of the drawings.

[Decorative Sheet]

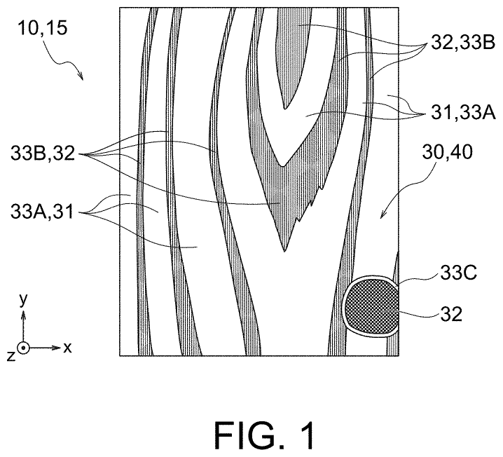

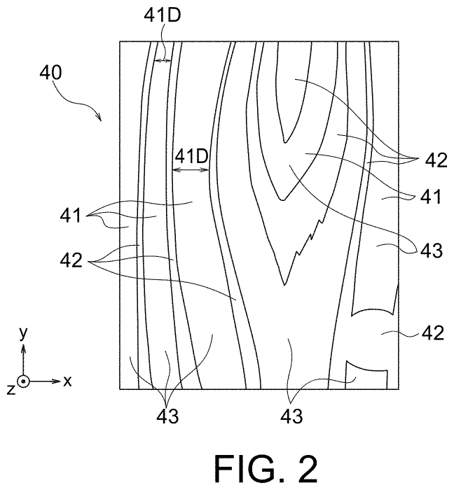

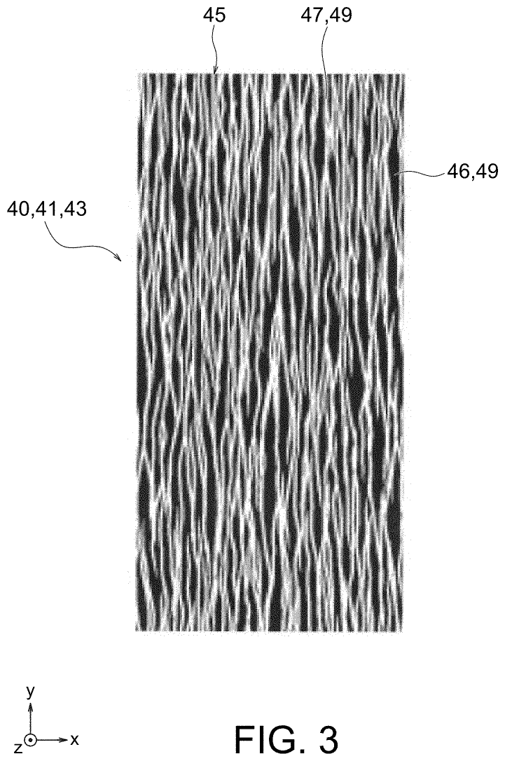

A decorative sheet 15 includes a design layer 30 and a raised layer 40. The design layer 30 includes a pattern of a surface of wood. FIG. 1 is a planar view illustrating a decorative material 10 and the decorative sheet 15. FIG. 1 illustrates a pattern of the surface of wood in the design layer 30. As illustrated in FIG. 2, the raised layer 40 includes raised regions 41. The raised layer 40 includes raised portions 43 provided in the raised regions 41. The decorative sheet 15 is designed to realize both excellent tactile sensation and natural features. The raised portions 43 may have configurations illustrated in FIG. 3 to FIG. 13, as specific configurations. The raised portions 43 may include an uneven surface 45 that is irregular. The raised portions 43 may include an uneven surface 45 like the surface of wood. The raised portions 43 may include an uneven surface 45 that includes protruding portions 46 and recessed portions 47, and at least one of the protruding portions 46 and the recessed portions 47 may include linear portions 49 of which at least one of the orientations and the lengths are not constant.

According to such raised portions 43, not only stepped formations at edges of the raised portions 43 but the recesses and protrusions on the surfaces of the raised portions 43 can be sensed by the sense of touch when touching the decorative sheet 15, which will be described later. That is to say, a strong tactile sensation, in other words tactile impression, can enhance or emphasize the sense of unevenness of the surface of the decorative sheet 15, and the design quality of the decorative sheet 15 is markedly improved. Also, eliminating the regularity of the uneven surface 45 can diminish impressions of artificialness. Thus, natural features can be expressed, and the design quality of the decorative sheet 15 can be synergistically improved in combination with the design layer 30 having the pattern of the surface of wood.

Note that “surface of wood” may be the skin of standing trees or the skin of trees before processing, i.e., tree bark. “Surface of wood” may also be a cross-sectional surface of wood. “Surface of wood” may be the surface of wood after the bark is removed, or may be the surface of milled lumber.

“Pattern of the surface of wood” means patterns expressing the surface of wood, or patterns mimicking the surface of wood. “Pattern of the surface of wood” may be a tree bark pattern. Tree bark patterns are patterns expressing or mimicking tree bark. Tree bark patterns may be patterns expressing or mimicking the skin of standing trees, or may be patterns expressing or mimicking the surface of trees before processing. “Pattern of the surface of wood” may be a wood-grain pattern. Wood-grain patterns are patterns expressing or mimicking wood grain. Accordingly, wood-grain patterns may be patterns expressing or mimicking a cross-sectional surface of wood. Wood-grain patterns may be patterns expressing or mimicking the surface of wood after the tree bark is removed, or may be patterns expressing or mimicking the surface of milled lumber.

“Uneven surface like the surface of wood” means a surface including recesses and protrusions expressing the surface of wood, or a surface including recesses and protrusions mimicking the surface of wood. “Uneven surface like the surface of wood” may be a tree-bark-like uneven surface, i.e., an uneven surface expressing or mimicking a tree bark. “Uneven surface like the surface of wood” may be a wood-grain-like uneven surface, i.e., an uneven surface expressing or mimicking a wood grain.

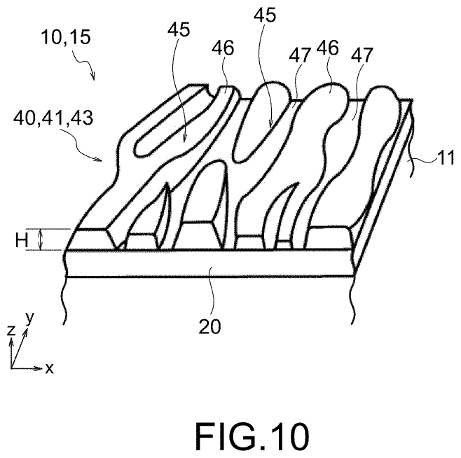

As illustrated in FIG. 10 to FIG. 13, the decorative material 10 may include a support member 11 and the decorative sheet 15. The support member 11 is a member to which the decorative sheet 15 is applied. Design quality is imparted to the support member 11 using the decorative sheet 15. The support member 11 may be a member made of a metal, a wood material, or a resin. The support member 11 made of a metal may be, for example, a member made of aluminum, a member made of steel, a member made of stainless steel, or a composite panel. The composite panel may include a core and a cover material bonded to the core. The core may be a board made of a resin. The cover material may be a board of aluminum, galvalume, stainless steel, or the like. The support member 11 made of a wood material may be an MDF (medium density fiberboard), a plywood board, or a particle board. The support member 11 may be a molded article. The support member 11 that is a molded article may be a sheet, a board, or a three-dimensional article formed of polyolefin, vinyl chloride resin, styrene resin, (meth)acrylic resin, polyester, polycarbonate, polyamide, polyimide, cellulose resin, phenol resin, rubber, or the like.

The support member 11 may be any of the following: furniture such as desks, chairs, cupboards, drawers, and so forth; interior materials of buildings such as walls, ceilings, floors, and so forth; exterior materials of buildings such as external walls, roofs, eaves ceilings, fences, gates, and so forth; doors and windows, or carpentry material, such as various types of doors such as entryway doors, handrails, baseboards, crown molding, windowsills, doorframes, decorative molding, and so forth; cases for home electronic appliances or OA equipment, surface decorative board in kitchen facilities or cookery furniture; and interior materials or exterior materials of vehicles. The support member 11 may also be part of these.

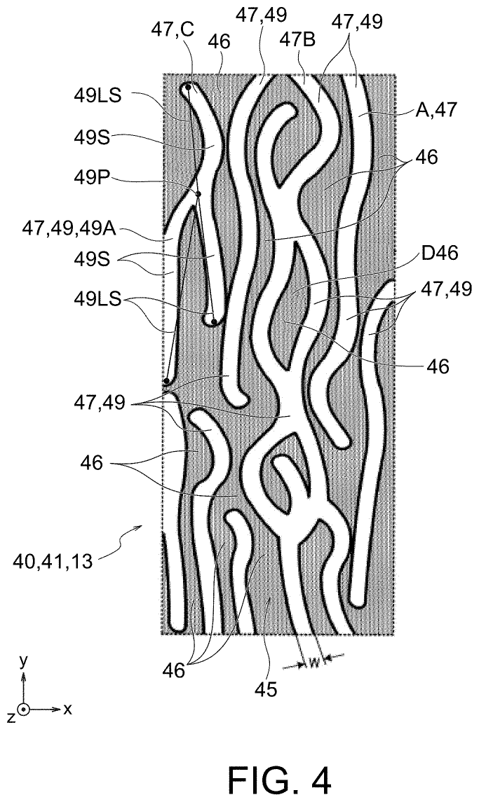

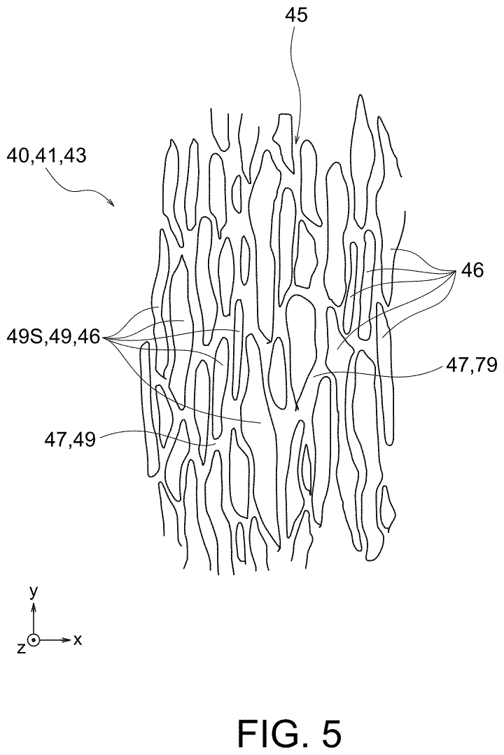

FIG. 1 is a planar view illustrating the decorative material 10 and the decorative sheet 15. FIG. 2 is a planar view illustrating the raised layer 40 of the decorative sheet 15. FIG. 3 to FIG. 10 are planar views illustrating examples of the raised portions 43 in an enlarged manner. The scale of enlargement of the raised portions 43 differs among FIG. 3, FIG. 4, and FIG. 5 to FIG. 9. FIG. 10 to FIG. 13 are perspective views schematically illustrating part of several examples of the decorative material 10 and the decorative sheet 15 in an enlarged manner.

In order to clarify the relation of directions among the drawings, some of the drawings show an x direction x, a y direction y, a z direction z, a first direction D1, a second direction D2, and a third direction D3, which are held in common, by way of arrows denoted by common symbols. The tip side of each arrow is a first side in each direction. An arrow heading toward the near side of the plane of the drawing along a direction perpendicular to the plane of the drawing is represented by a symbol in which a dot is inside of a circle, as shown in FIG. 1. The x direction and the y direction here are directions in which the decorative sheet 15 extends. The z direction is a thickness direction of the decorative material 10 and the decorative sheet 15. Accordingly, FIG. 1 is a diagram observing the decorative material 10 and the decorative sheet 15 from the first side in the z direction (in planar view). In order to facilitate understanding, in FIG. 3 and FIG. 4, the recessed portions 47 are represented by white, and the protruding portions 46 are represented by black (FIG. 3) or gray (FIG. 4). The recessed portions 47 and the protruding portions 46 do not have to be color coded in the actual decorative sheet 15.

As described above, the decorative sheet 15 includes the design layer 30. The design layer 30 includes a pattern of the surface of wood. The decorative sheet 15 expresses the surface of wood. The wood expressed by the decorative sheet 15 is not limited in particular, and may be a skin of wood such as cedar, cypress, walnut, pine, cherry, or the like. Also, as illustrated in FIG. 10 to FIG. 13, the decorative sheet 15 may include a substrate 20. The components will be described below.

### <Substrate>

The substrate 20 may be in a sheet-like form. The substrate 20 may be a film, a sheet, a flat board, a curved board, or the like. The substrate 20 may be a substrate that is normally used for decorative sheets. The substrate 20 is not limited in particular. The substrate 20 may be a resin substrate, a metal substrate, a ceramic-industry-based substrate, a fiber substrate, a wood substrate, or the like. The material of the substrate 20 can be selected as appropriate in accordance with the use of the decorative sheet 15. Each of the above substrates may be used alone. The substrate 20 may be, for example, a laminate of any combination of substrates, such as a composite of a resin substrate and a wood substrate, a composite of a resin substrate and a metal substrate, or the like. In a case in which the substrate 20 is a laminate, a primer layer may be included between the layers of the laminate.

The material of the resin substrate 20 can be prepared from various types of synthetic resins. Examples of synthetic resins include polyolefin resins such as polyethylene, polypropylene, polymethylpentene, ionomers, and various types of polyolefin thermoplastic elastomers, vinyl chloride-based resins such as polyvinyl chloride, polyvinylidene chloride, and vinyl chloride-vinyl acetate copolymers, polyester resins such as polyethylene terephthalate, polybutylene terephthalate, polyethylene naphthalate, ethylene glycol-terephthalic acid-isophthalic acid copolymers, and polyester thermoplastic elastomers, acrylic resins such as polymethyl (meth)acrylate, polyethyl (meth)acrylate, polybutyl (meth)acrylate, and methyl (meth)acrylate-butyl (meth)acrylate copolymers, polyamide resins as typified by nylon 6, nylon 66, and so forth, cellulose-based resins such as cellulose triacetate, cellophane, and celluloid, styrene-based resins such as polystyrene, acrylonitrile-styrene copolymers, and acrylonitrile-butadiene-styrene copolymer (ABS), polyvinyl alcohol, ethylene-vinyl acetate copolymers, ethylene-vinyl alcohol copolymers, polycarbonate resins, polyarylate resins, polyimide resins, and so forth. In the present specification, “(meth)acrylic acid”, “(meth)acrylate”, and “(meth)acryloyl group” mean “acrylic acid or methacrylic acid”, “acrylate or methacrylate”, and “acryloyl group or methacryloyl group”, respectively.

The material of the metal substrate 20 may be, for example, aluminum or an alloy that includes aluminum, such as duralumin or the like, iron or an alloy that includes iron, such as carbon steel, stainless steel, or the like, copper or an alloy that includes copper, such as brass, bronze, or the like, titanium, or the like. The substrate 20 may include these metals as a plated layer.

The material of the ceramic-industry-based substrate 20 may be, for example, a non-ceramic ceramic-industry-based material such as cement, ALC (Autoclaved Lightweight aerated Concrete), plaster, calcium silicate, or wood chip cement, or a ceramic-based ceramic-industry-based material such as pottery, earthenware, glass, or enamel.

The fiber substrate 20 may be, for example, a paper substrate such as tissue paper, kraft paper, titanium paper, linter paper, paperboard, or base paper for gypsum board. A resin such as acrylic resin, styrene-butadiene rubber, melamine resin, urethane resin, or the like may be added to the paper substrate (resin impregnation following papermaking, or incorporation during papermaking) in order to increase the strength between fibers of the paper substrate or interlayer strength between other layers and the paper substrate, and/or to suppress fluffing. Examples of paper substrates with resin added thereto include reinforced paper, resin-impregnated paper, and so forth. An example of the fiber substrate 20 is a vinyl wallpaper raw material in which a vinyl chloride resin layer is formed on the surface of a paper substrate, or the like, and this fiber substrate 20 can be used in the field of building materials. Examples of the fiber substrate 20 include coated paper, art paper, sulfuric acid paper, glassine paper, parchment paper, paraffin paper, Japanese washi paper, and so forth, which are used in printing in the field of business offices or in normal printing and in packaging, and so forth. Examples of the fiber substrate 20 also include woven cloth and non-woven cloth of various types of fiber, having an appearance and nature similar to those of paper. Examples of the various types of fiber include protein-based or cellulose-based natural fibers such as silk, cotton, and hemp, and inorganic fibers such as glass fiber, asbestos fiber, potassium titanate fiber, alumina fiber, silica fiber, and carbon fiber. Examples of the various types of fiber also include synthetic resin fibers such as polyester fiber, acrylic fiber, and Vinylon fiber.

Examples of the wood substrate 20 include single panels, plywood, laminated wood, particleboard, MDF (medium density fiberboard), and so forth of various types of wood materials such as cedar, cypress, pine, zelkova, oak, Japanese oak, lauan, teak, and so forth.

The thickness of the substrate 20 is not limited in particular. From the perspective of mechanical strength, handleability, and economy, the thickness of the substrate 20 is preferably 0.01 mm or more and 100 mm or less, more preferably 0.05 mm or more and 50 mm or less, and even more preferably 0.1 mm or more and 30 mm or less.

In order to improve close contact to other components making up the decorative sheet 15, or to strengthen adhesion to the support member 11, the substrate 20 may be subjected to surface treatment on one surface or both surfaces thereof. Examples of surface treatment include oxidization, physical surface treatment such as roughening and so forth, or chemical surface treatment and so forth. Examples of oxidization include corona discharge treatment, chromium oxidation treatment, flame treatment, hot air treatment, ozone-ultraviolet treatment, and so forth. Examples of roughening include sandblasting, solvent treatment, and so forth. These surface treatments can be selected as appropriate, in accordance with the type of the substrate 20. Corona discharge treatment is preferable from the perspectives of effects of the surface treatment, operability, and so forth. A primer layer may further be provided on the surface of the substrate 20, for example, in order to improve close contact between the substrate 20 and other layers and strengthen adhesion to the support member 11.

(Design Layer)

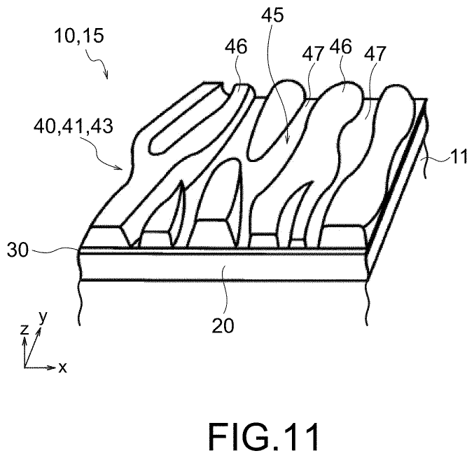

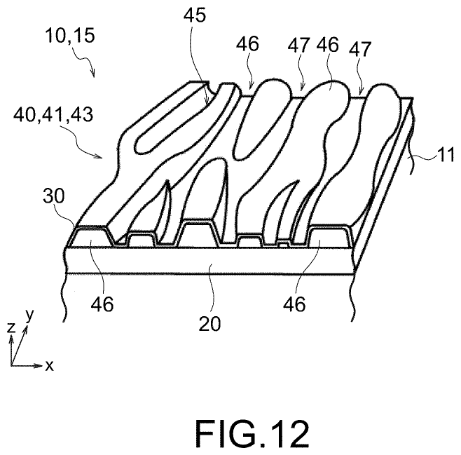

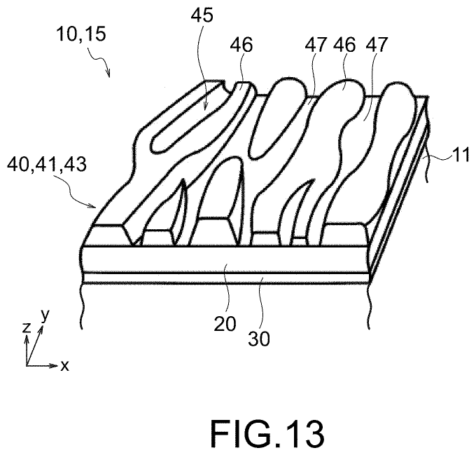

As illustrated in FIG. 11, the design layer 30 may be positioned between the substrate 20 and the raised layer 40. As illustrated in FIG. 12, the design layer 30 may be disposed on a surface of the raised layer 40 that is on the opposite side from the substrate 20. In the example illustrated in FIG. 12, the raised layer 40 is positioned between the substrate 20 and the design layer 30 in the z direction. As illustrated in FIG. 13, the design layer 30 may be provided on a surface of the substrate 20 that is on the opposite side from the raised layer 40. In the example illustrated in FIG. 13, the substrate 20 is positioned between the design layer 30 and the raised layer 40 in the z direction. In the example illustrated in FIG. 12, the design layer 30 extends along the uneven surface formed by the raised layer 40, and forms recesses and protrusions. Note that the decorative sheet 15 illustrated in FIG. 10 does not include the design layer 30. The decorative sheet 15 illustrated in FIG. 10 is made up of the substrate 20 and the raised layer 40, with the design layer 30 omitted.

The design layer 30 expresses a design. The design layer 30 imparts design quality to the decorative sheet 15. As illustrated in FIG. 1, the design layer 30 may be a motif layer having a pattern of the surface of wood. A pattern of the surface of wood means a pattern expressing the surface of wood, or a pattern mimicking the surface of wood, as described above. In the example illustrated in FIG. 1, the design layer 30 is a motif layer having a wood-grain pattern. Note, however, that the design layer 30 may be a motif layer having a tree bark pattern.

As illustrated in FIG. 1, the design layer 30 includes first regions 31 and second regions 32. As illustrated in FIG. 1, the design layer 30 may be sectioned into one of the first regions 31 and the second regions 32. In the example that is illustrated, the pattern of the surface of wood of the design layer 30 includes light and dark shades. The design layer 30 may be divided into regions in accordance with the light and dark shades of the pattern of the surface of wood.

In the example illustrated in FIG. 1, the design layer 30 is divided into regions in accordance with the light and dark shades of the wood-grain pattern. That is to say, the density of the pattern in the first regions 31 is different from the density of the pattern in the second regions 32. In the example illustrated in FIG. 1, the first regions 31 are light portions in the wood-grain pattern, and the second regions 32 are dark portions in the wood-grain pattern. In the example illustrated in FIG. 1, the first regions 31 include a portion of earlywood 33A forming growth rings in the wood-grain pattern. The second regions 32 include one or more of a portion of latewood 33B forming growth rings in the wood-grain pattern, a knot 33C, and a duct. The earlywood 33A, also referred to as springwood, is a portion that grows in the early spring, and is a portion that grows fast. The latewood 33B, also referred to as summer wood or autumn wood, is a portion that grows in summer and thereafter, and is a portion that grows slowly.

The density of the pattern is evaluated by the L* value in the L*a*b color space. In a case in which the L* value measured on the pattern is high, this pattern is “light (portion)”, and the density of this pattern is “low”. In a case in which the L* value measured on the pattern is low, this pattern is “dark (portion)”, and the density of this pattern is “high”. The L* value in the L*a*b color space is identified by measuring reflected light from the decorative sheet by a model No. V-670, manufactured by JASCO Corporation.

As other examples, the patterns expressed by the design layer 30 may be patterns such as stone grain patterns (cleaved surface of granite, etc.), cloth patterns, leather grain patterns, tiled patterns (including grouting grooves), laid-brick patterns (including grouting grooves), sand grain patterns, pear-skin finish patterns, light engraving patterns, geometric patterns, letters, shapes, regular patterns, abstract patterns, or the like, and these may be combined into patterns such as marquetry, patchwork, or the like. The patterns of the motif layer included in the design layer 30 may be formed by using multicolor printing by process colors of yellow, red, blue, black, and so forth. The patterns of the motif layer may be formed by using multicolor printing by spot colors in which plates for individual colors making up the pattern are prepared and used, and so forth.

The design layer 30 includes an arrangement in which colorants such as pigments, dyes, or the like, are laid out as appropriate such that the intended design is obtained. The design layer 30 can be formed by printing techniques such as offset printing, flexographic printing, gravure printing, screen printing, spray printing, inkjet printing, and so forth, and by transfer techniques in which a printed motif is transferred, and so forth. The design layer 30 may be a single layer, or may be formed of two or more layers.

The ink used in forming the design layer 30 may be an ink in which materials such as a colorant, such as a pigment, a dye, or the like, an extender pigment, a solvent, a stabilizer, a plasticizer, a catalyst, and a curing agent or the like are mixed into a binder resin as appropriate. The binder resin is not limited in particular. Examples of the binder resin include acrylic resins, styrene resins, polyester resins, urethane resins, chlorinated polyolefin resins, vinyl chloride-vinyl acetate copolymer resins, polyvinyl butyral resins, alkyd resins, petroleum resins, ketone resins, epoxy resins, melamine resins, fluororesins, silicone-based resins, cellulose derivatives, rubber-based resins, and so forth. These resins may be used alone, or two or more thereof may be mixed and used. The colorant is not limited in particular. Examples of colorants include inorganic pigments such as carbon black (soot-based brush-writing ink), iron black, titanium white, antimony white, lead yellow, titanium yellow, red iron oxide, cadmium red, ultramarine, and cobalt blue, organic pigments or dyes such as quinacridone red, isoindolinone yellow, nickel azo complexes, phthalocyanine blue, and azomethine azo black, metallic pigments made up of scale-like foil flakes of aluminum, brass, or the like, and pearlescent (pearl) pigments made up of scale-like foil flakes of titanium dioxide-coated mica, basic lead carbonate, or the like. The design layer 30 may include additives such as antioxidants, ultraviolet absorbers, light stabilizers, and so forth.

From the perspective of exhibiting good design quality, the thickness of the design layer 30 is preferably 0.1 μm or more and 40 μm or less, more preferably 0.3 μm or more and 20 μm or less, and even more preferably 0.5 μm or more and 10 μm or less.

<Raised Layer>

The raised layer 40 functions as an unevenness imparting layer. The raised layer 40 can contribute to improved design quality and decorativeness of the decorative sheet 15. The raised layer 40 enables both tactile sensation and natural features that differs from that in the conventional art. The raised layer 40 can also exhibit a delustering function.

The raised layer 40 includes the raised regions 41 and non-raised regions 42, as illustrated in FIG. 2. The raised layer 40 includes raised portions 43 provided on the raised regions 41. The raised portions 43 may be provided only on the raised regions 41. The raised regions 41 is overlaid to part of regions of the design layer 30 in the z direction. The z direction is a stacking direction in which the substrate 20, the design layer 30, and the raised layer 40 are stacked. The raised regions 41 may be overlaid ton one of the first regions 31 and the second regions 32 of the design layer 30. The non-raised regions 42 may be overlaid to the other of the first regions 31 and the second regions 32 of the design layer 30. In the example that is illustrated, the raised regions 41 is overlaid only to the first regions 31, and the non-raised region 42 is overlaid only to the second regions 32. Unlike the illustrated example, the raised regions 41 may be overlaid only to the second regions 32, and the non-raised regions 42 may be overlaid only to the first regions 31. The decorative sheet 15 may include a single raised portion 43. The decorative sheet 15 may include a plurality of raised portions 43 away from each other. According to the raised portions 43, tactile sensation can be imparted by stepped portions at the edges of the raised portions 43, in other words, by the stepped portions at boundaries between the raised regions 41 and the non-raised regions 42. The layout of the raised regions 41 and the non-raised regions 42 will be described later.

FIG. 3 to FIG. 13 illustrate one raised portion 43. The raised portion 43 includes the uneven surface 45 that is irregular, as illustrated in the drawings. The uneven surface 45 includes the protruding portions 46 and the recessed portions 47. The protruding portions 46 and the recessed portions 47 that form the uneven surface 45 that is irregular may have irregularity in layout. The protruding portions 46 and the recessed portions 47 may have irregularity in shape. FIG. 3 illustrates a relatively broad range of the raised portion 43. As can be understood well from FIG. 3, the uneven surface 45 of the raised portion 43 may be like the surface of wood. In the example illustrated in FIG. 3 to FIG. 13, the uneven surface 45 includes a wood-grain pattern or a tree bark pattern.

In all of the examples illustrated in FIG. 2 to FIG. 13, at least one of the protruding portions 46 and the recessed portions 47 include the linear portions 49 in which at least one of orientations and lengths are not constant. According to the raised portion 43 including such linear portions 49, the uneven surface 45 can be made to be irregular. According to the raised portion 43 including such linear portions 49, the uneven surface 45 can be made to be like the surface of wood.

According to the raised portion 43, tactile sensation can be imparted at an inner region thereof by the stepped portions between the protruding portions 46 and the recessed portion 47. That is to say, not only can the raised layer 40 impart tactile sensation at the edge portions of the raised portion 43, but tactile sensation can also be imparted at an inner portion of the raised portion 43 as well. Accordingly, recesses and protrusions on the surface of the decorative sheet 15 can be enhanced or emphasized by a strong tactile sensation.

In addition, eliminating the regularity of the uneven surface 45 can suppress impressions of artificialness when observing the uneven surface 45. Accordingly, the raised portion 43 can express natural features, and the design quality can be improved synergistically by the combination thereof with the design layer 30 that includes the pattern of the surface of wood.

As described in the section of the Background Art, the raised portions used in conventional decorative sheets unavoidably had uneven surfaces that had regularity, due to the regularity of the plates used for fabrication thereof. Tactile sensation can be imparted by uneven surfaces with regularity as well. However, in order to sufficiently enhance the tactile sensation obtained from the uneven surface, great distances between the protruding portions and widths of the recessed portions have to be secured. On the other hand, securing great distances between the protruding portions and widths of the recessed portions makes the regularity of the uneven surface to be conspicuous, and the impressions of artificialness become stronger. In particular, conventional raised portions exhibited unnaturalness in combinations with design layers having patterns of natural objects. That is to say, with conventional decorative sheets, attempts to obtain sufficient tactile sensation bring about deterioration in visually perceived design quality. Conversely, reducing distances between the protruding portions and widths of the recessed portions can reduce the impressions of artificialness, due to the resolution limit of the sense of sight. However, sufficient tactile sensation cannot be obtained from the uneven surface at this time. In this way, conventional decorative sheets are not able to capture both tactile sensation and natural features even though a raised layer including raised portions is provided, and design quality could not be sufficiently effectively improved.

On the other hand, according to the uneven surface 45 that is irregular, or the uneven surface 45 that is wood-surface-like, natural features that are sensed by the sense of sight can be imparted while enhancing the tactile sensation that is sensed by the sense of touch. As a result, the design quality of the decorative sheet 15 that is sensed through the sense of touch and the sense of sight can be dramatically improved. The effects of improved design quality are synergistically effective and are pronounced in a combination with a design layer 30 expressing a natural object, such as a design layer 30 having a pattern of the surface of wood, for example.

Various configurations can be employed for the uneven surface 45 that the design layer 30 forms. For example, as illustrated in FIG. 4, at least part of the uneven surface 45 may include a plurality of the recessed portions 47 that are linear and that have a thickness that is recognizable by tactile sensation, with the protruding portions 46 formed between adjacent recessed portions 47 that are linear. Also, at least part of the protruding portions 46 may be surrounded over the full perimeter thereof by the recessed portions 47 that are adjacent to the protruding portions 46 in planar view. According to this example, the uneven surface 45 is recognizable by tactile sensation, and a delustered nature can be imparted to the surface thereof.

The layout of the raised regions 41 on which the raised portion 43 is provided can be decided in accordance with the design to be expressed by the design layer 30. For example, the uneven surface 45 of the raised portion 43 can be applied to patterns with fine surface recesses and protrusions in a region on the surface of a weathered-looking wood board in which the latewood portions of the growth rings are raised up (to regions of earlywood portions in particular), or to patterns with fine surface recesses and protrusions in a region other than ducts in a wood plate having a group of duct grooves. As other examples, the uneven surface 45 of the raised portion 43 can be applied to patterns with fine surface recesses and protrusions of the surfaces of tiles and bricks, in tiling or brick laying surfaces having grouting grooves, stone grain patterns including structures with fine surface recesses and protrusions for stone plate surfaces such as cleaved surfaces of granite, or the like, cloth patterns including structures in which fibers or threads are woven, leather grain patterns (also referred to as leather texture patterns), fine surface recesses and protrusions for sand grain patterns, fine surface recesses and protrusions for pear-skin finish patterns, geometric patterns, letters, shapes, regular patterns, abstract patterns, and so forth, and combinations thereof into patterns such as marquetry, patchwork, or the like.

Specific configurations and specific layouts of the raised portion 43 will be further described below.

(Recessed Portions and Protruding Portions)

As illustrated in FIG. 3 to FIG. 13, at least one of the protruding portions 46 and the recessed portions 47 may be the linear portions 49 of which at least one of the orientations and the lengths are not constant. Both of the protruding portions 46 and the recessed portions 47 may be the linear portions 49 of which at least one of the orientations and the lengths are not constant.

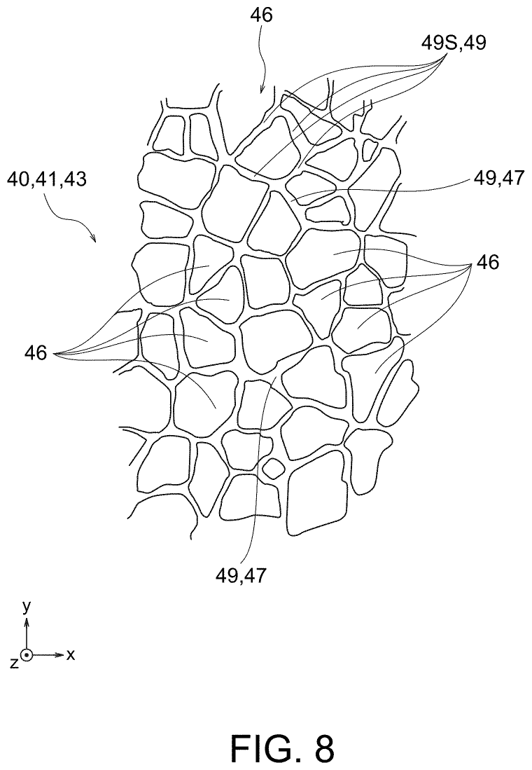

Now, when determining whether the orientations of the linear portions 49 or the lengths of the linear portions 49 are constant or not constant, the orientations of the linear portions 49 and the lengths of the linear portions 49 are identified for each small segment 49S in which there is no branching or intersection with other linear portions 49. In other words, the orientations and lengths of the linear portions 49 are identified by straight line segments 49LS that connect both ends of the small segments 49S of the linear portions 49 obtained by dividing at branch points and intersection points. The small segments 49S are linear portions extending between both ends, and connect to a plurality of other small segments 49S only at the end portions. The linear portions 49 can also be said to be a collection of the small segments 49S. In a case in which the linear portions 49 are configured in a mesh-like form as in FIG. 5 and FIG. 8, for example, the linear portions 49 include a plurality of the small segments 49S that are linear. Each small segment 49S, at an end portion thereof, connects to a plurality of other small segments 49S, or makes up an end portion of the linear portion 49. The end portions of the linear portions 49 may be positioned at the edges of the raised portion 43.

In a case in which directions of the straight line segments 49LS connecting both ends of the small segments 49S are not substantially parallel, the orientations of the linear portions 49 are evaluated as not being constant. In a case in which the distances between both ends of the small segments 49S, i.e., the lengths of the straight line segments 49LS, are not substantially constant, the lengths of the linear portions 49 are evaluated as not being constant. To say that the directions of the straight line segments 49LS connecting both ends of the small segments 49S are substantially parallel means that the directions of the straight line segments 49LS that are objects of investigation are within an angle range of 10° or less, i.e., the greatest angle between two straight line segments 49LS that are included as objects of investigation is 10° or less. To say that the distances between both ends of the small segments 49S are substantially constant means that a difference (μm) between a greatest value and a smallest value of lengths of the straight line segments 49LS that are objects of investigation is 10% of an average value of lengths (μm) of the straight line segments 49LS that are objects of investigation, or less. Also, the small segments 49S that are the object of investigation regarding orientation and length are randomly selected fifty small segments 49S.

For example, a linear portion 49A that is made up of a recessed portion C illustrated in FIG. 4 has one branch point or intersection point 49P. This linear portion 49A is sectioned into three small segments by the branch point or the intersection point 49P. Three orientations and lengths of the linear portion 49A are identified by the straight line segments 49LS connecting both ends of each small segment 49S.

The magnitude of the direction in which the linear portion 49 extends is the full length of the linear portion 49. The magnitude of the direction orthogonal to the direction in which the linear portion 49 extends is the width of the linear portion 49. The magnitude of the linear portion 49 in the z direction is the depth of the linear portion 49.

FIG. 3 to FIG. 9 each exemplify the layout and shape of the protruding portions 46 and the recessed portions 47 in planar view. The protruding portions 46 illustrated in each of FIG. 3 to FIG. 9 may be the recessed portions 47, and the recessed portions 47 illustrated in each of FIG. 3 to FIG. 9 may be the protruding portions 46.

In the example illustrated in FIG. 3, the recessed portions 47 serving as the linear portions 49 include curved-line shapes. According to the linear portions 49 with curved-line shapes, surfaces of a greater number of types of woods can be more authentically expressed. The recessed portions 47 meander. The meandering of the recessed portions 47 is not in a regular manner, but has irregular periods and/or breadths of swing (amplitudes). Note, however, that while the orientations of the linear portions 49 cannot be said to be constant, the orientations thereof are aligned, and are not greatly dispersed. Note that the expression that the orientations of the linear portions 49 are “aligned” means that the orientations of the linear portions 49 or the small segments 49S defined as above are within an angle range of 50° or less in planar view, preferably within an angle range of 40° or less, more preferably within an angle range of 30° or less, and even more preferably within an angle range of 20° or less. Aligning the orientations of the linear portion 49 to a certain extent, although not constant, enables impressions of artificialness to be effectively suppressed, and natural features to be created.

As illustrated in FIG. 4, the recessed portions 47 may be a recessed portion A that is independent. The linear portion 49 made of the recessed portion A includes a single small segment 49S. As illustrated in FIG. 4, the recessed portions 47 may include a recessed portion B that repeats contact and separation along the way. The linear portion 49 made of the recessed portion B includes a plurality of the single small segments 49S. As illustrated in FIG. 4, the recessed portions 47 may include the recessed portion C that merges along the way with a plurality of adjacent recessed portions and becomes one. The linear portion 49 made of the recessed portion C includes three small segments 49S. The decorative sheet 15 may include one or more of the recessed portion A, the recessed portion B, and the recessed portion C. The decorative sheet 15 may include two or more of the recessed portion A, the recessed portion B, and the recessed portion C in a coexisting manner. For example, the decorative sheet 15 may include the recessed portion B and the recessed portion C. Portions between adjacent recessed portions 47 are the protruding portions 46.

The protruding portions 46 are bulging portions formed between adjacent recessed portions 47. The protruding portions 46 may have shapes that are defined by the recessed portions 47 that are adjacent to the protruding portions 46. As described above, the recessed portions 47 may have configurations such as the recessed portion A, the recessed portion B, and the recessed portion C in FIG. 4. Thus, various configurations may be made regarding the protruding portions 46 as well, in accordance with the configurations of the recessed portions 47.

In the decorative sheet 15 illustrated in FIG. 4, the protruding portions 46 include a protruding portion D that is surrounded by the recessed portions 47 on the full perimeter thereof in planar view. The protruding portion may be irregularly laid out in the raised portion 43 in planar view. The shape in planar view of the protruding portion included in one raised portion 43 may be an irregular shape, rather than being a regular geometric shape such as a triangle, a square, a circle, and ellipse, or the like. The area of the protruding portion in planar view may irregularly differ among a plurality of the protruding portions. That is to say, the area may differ from each other in planar view among the plurality of protruding portions. The term “irregular shape” means a shape that has one of the following features.
(1) The shapes of the plurality of protruding portions in planar view are not all congruent. At least two protruding portions have different shapes and sizes from each other. All of the plurality of protruding portions may have shapes and sizes that differ from each other. Two or more protruding portions 46 that are congruent with each other or similar (analogous) to each other may be included in the raised portion 43.
(2) The shapes of the plurality of protruding portions in planar view differ from relatively monotonous shapes such as regular polygons, circles, ellipses, cardioids (heart shapes), and so forth. For example, the outlines of the protruding portions may be approximated by a combination of complicated functions, such as polynomials, infinite series, and so forth.
(3) Having the features of both (1) and (2).

The dimensions of the protruding portions D in planar view can be set taking into consideration realization of tactile sensation and natural features. The greatest size of the protruding portions D in the x direction preferably is 30 μm or more and 500 μm or less, and more preferably is 100 μm or more and 300 μm or less. The greatest size of the protruding portions D in the y direction preferably is 40 μm or more and 20,000 μm or less, and more preferably is 400 μm or more and 8000 μm or less.

In addition to the protruding portions D of which the full perimeter is surrounded by recessed portions 47 in planar view as illustrated in FIG. 4, the decorative sheet 15 may include protruding portions 46 of which part is not surrounded by recessed portions 47.

The lengths of the linear portions 49 are not limited in particular. In at least part of the linear portions 49, both ends thereof may be positioned at edges of the raised portion 43. At least part of the linear portions 49 may include one end portion or both end portions positioned inside the raised portion 43. That is to say, just one end of the linear portions 49 may be positioned at an edge of the raised portion 43. Both ends of the linear portions 49 may be positioned inside the raised portion 43. The end portion positions of these linear portions 49 may differ among the linear portions 49 included in one raised portion 43.

A width W (see FIG. 4) of the linear portions 49 is not limited in particular. The width W of the linear portions 49 may be 50 μm or more and 250 μm or less. The width W may differ among a plurality of the linear portions 49. The width W may differ at each position along a longitudinal direction of one linear portion 49. The width W of one linear portion 49 may gradually increase or gradually decrease along the longitudinal direction thereof. The change in the width W in this example may be continuous, or may be stepwise. The change in the width W in this example may be irregular. The width W of one linear portion 49 may decrease from a first side toward a second side in the longitudinal direction in a part of a region of the linear portion 49 along the longitudinal direction of the linear portion 49, and may increase from the first side toward the second side in the longitudinal direction in another part of a region of the linear portion 49 along the longitudinal direction of this linear portion 49.

A height difference H (μm) of the linear portions 49, i.e., the height difference H (μm) between the recessed portions 47 and the protruding portions 46 is a difference in the z direction between the portion of the recessed portions 47 that is the smallest (lowest) and the portion of the protruding portions 46 that is the greatest (highest). The height difference H can be said to be the depth of the recessed portions 47, and can also be said to be the height of the protruding portions 46. The height difference H is not limited in particular. The height difference H may be 10 μm or more and 200 μm or less. Height differences H associated with a plurality of the linear portions 49 may be the same, or may be different from each other. The height difference H associated with one linear portion 49 may be constant along the longitudinal direction of this linear portion 49, or may change.

The cross-sectional shapes of cross-sections orthogonal to the longitudinal direction of the linear portions 49 are not limited in particular. The cross-sectional shapes of cross-sections orthogonal to the longitudinal direction of the linear portions 49 may be any shape, such as a semicircle, a semi-ellipse, a triangle, a square, a pentagon, a hexagon, another polygon, an irregular geometric shape, or the like.

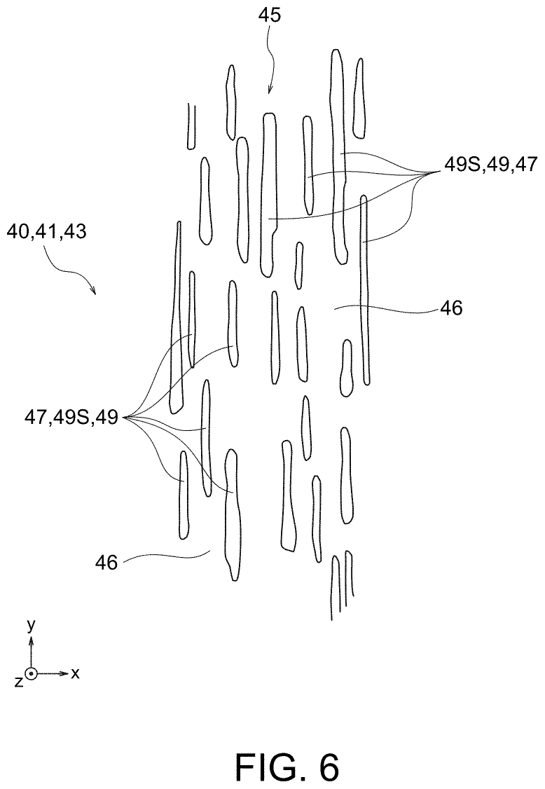

FIG. 5 is a diagram in which part of FIG. 3 is enlarged. FIG. 5 illustrates the raised portion 43 in a higher magnification than in FIG. 4. Also, FIG. 6 to FIG. 9 are planar views illustrating other raised portions 43.

In the examples illustrated in FIG. 5 to FIG. 9, the recessed portions 47 are linear portions 49 of which at least one of the orientations and the lengths are not constant. Accordingly, the uneven surface 45 of the raised portion 43 is irregular and is wood-surface-like in the examples illustrated in FIG. 5 to FIG. 9. According to the raised portions 43 illustrated in FIG. 5 to FIG. 9, tactile sensation can be improved, and natural features can be expressed. In the examples illustrated in FIG. 5 to FIG. 9, both of the protruding portions 46 and the recessed portions 47 are linear portions 49 of which at least one of the orientations and the lengths are not constant. The decorative sheets 15 illustrated in FIG. 5 and FIG. 7 to FIG. 9 include linear portions 49 of which the orientations are not constant. The decorative sheets 15 illustrated in FIG. 5 to FIG. 9 include linear portions 49 of which the lengths are not constant.

The uneven surface 45 of the raised portion 43 illustrated in FIG. 5 may have the following configuration.
The linear portions 49 made up of the recessed portions 47 include curved-line shapes.
The widths of the linear portions 49 made up of the recessed portions 47 are 250 μm or less.
The orientations of the linear portions 49 made up of the recessed portions 47 are aligned, and are not greatly dispersed. That is to say, the orientations of the linear portions 49 made up of the recessed portions 47 in one raised portion 43 are within an angle range of 50° or less in planar view, preferably 40° or less, more preferably 30° or less, and even more preferably 20° or less.
The orientations of the linear portions 49 made up of the protruding portions 46 are aligned, and are not greatly dispersed. That is to say, the orientations of the linear portions 49 made up of the protruding portions 46 in one raised portion 43 are within an angle range of 50° or less in planar view, preferably 40° or less, more preferably 30° or less, and even more preferably 20° or less.
The full perimeter of at least part of the protruding portions 46 is surrounded by the linear portions 49 made up of the recessed portions 47.
The linear portions 49 made up of the recessed portions 47 may include a plurality of small segments 49S that are linear, and each of the small segments, at an end portion thereof, may connect to two other small segments 49S, may make up an end portion of a linear portion 49, or may be positioned at an edge of the raised portion 43.

According to the above configuration, the uneven surface 45 of the raised portion 43 illustrated in FIG. 5 is made to be irregular, and is wood-surface-like. Thus, tactile sensation can be improved and natural features can be expressed, and the design quality of the decorative sheet 15 can be improved.

The uneven surface 45 of the raised portion 43 illustrated in FIG. 6 may have the following configuration.
The linear portions 49 made up of the recessed portions 47 include straight-line shapes, but the lengths of the linear portions 49 are not constant.
The widths of the linear portions 49 made up of the recessed portions 47 are 250 μm or less.
The lengths of the linear portions 49 made up of the recessed portions 47 are 100 μm or more and 1000 μm or less.
At least part of the linear portions 49 made up of the recessed portions 47 include one end portion or both end portions thereof positioned inside the raised portion 43.
The orientations of the linear portions 49 are aligned, and are not greatly dispersed. That is to say, the orientations of the linear portions 49 included in one raised portion 43 are within an angle range of 50° or less in planar view, preferably 40° or less, more preferably 30° or less, and even more preferably 20° or less.

According to the above configuration, the uneven surface 45 of the raised portion 43 illustrated in FIG. 6 is made to be irregular, and is wood-surface-like. Thus, tactile sensation can be improved and natural features can be expressed.

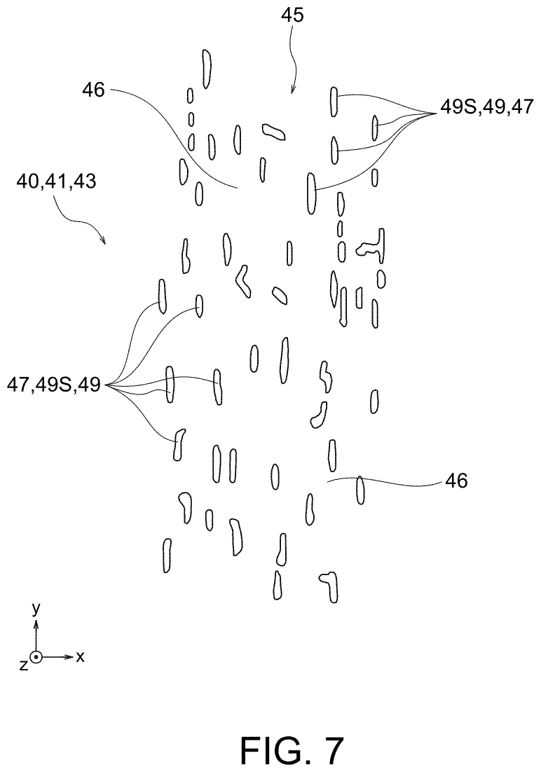

The uneven surface 45 of the raised portion 43 illustrated in FIG. 7 may have the following configuration.
The linear portions 49 made up of the recessed portions 47 include straight-line shapes, but the lengths of the linear portions 49 are not constant.
The widths of the linear portions 49 made up of the recessed portions 47 are 250 μm or less.
The lengths of the linear portions 49 made up of the recessed portions 47 are 20 μm or more and 250 μm or less.
At least part of the linear portions 49 made up of the recessed portions 47 may include one end portion or both end portions thereof positioned inside the raised portion 43.

According to the above configuration, the uneven surface 45 of the raised portion 43 illustrated in FIG. 7 is made to be irregular, and is wood-surface-like. Thus, tactile sensation can be improved and natural features can be expressed, and the design quality of the decorative sheet 15 can be improved.

The uneven surface 45 of the raised portion 43 illustrated in FIG. 8 may have the following configuration.
The linear portions 49 made up of the recessed portions 47 include curved-line shapes.
The widths of the linear portions 49 made up of the recessed portions 47 are 250 μm or less.
The orientations of the linear portions 49 made up of the recessed portions 47 are greatly dispersed. The orientations of any two linear portions 49 included in one raised portion 43 are inclined by 70° or more at most, preferably inclined by 80° or more, and more preferably inclined by 90°.
The full perimeter of at least part of the protruding portions 46 is surrounded by the linear portions 49 made up of the recessed portions 47.
The linear portions 49 made up of the recessed portions 47 include a plurality of small segments 49S that are linear, and each of the small segments may, at an end portion thereof, connects to two other small segments 49S, makes up an end portion of a linear portion 49, or is positioned at an edge of the raised portion 43.

According to the above configuration, the uneven surface 45 of the raised portion 43 illustrated in FIG. 8 is made to be irregular, and is wood-surface-like. Thus, tactile sensation can be improved and natural features can be expressed, and the design quality of the decorative sheet 15 can be improved.

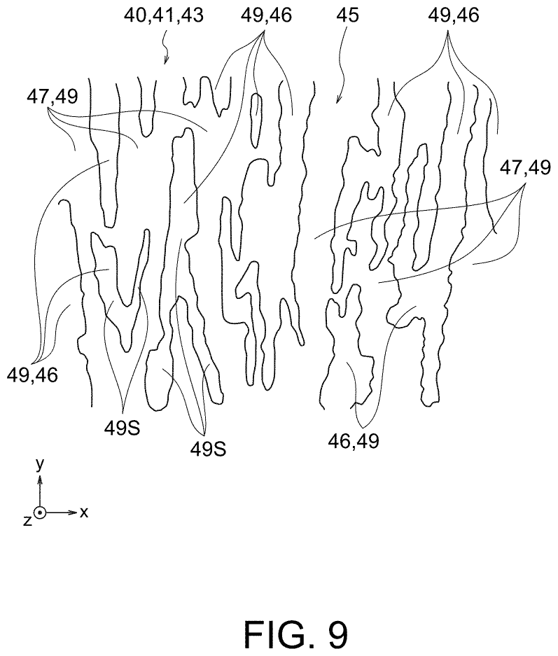

The uneven surface 45 of the raised portion 43 illustrated in FIG. 9 may have the following configuration.
The linear portions 49 made up of the recessed portions 47 include curved-line shapes.
The linear portions 49 made up of the protruding portions 46 include curved-line shapes.
The widths of the linear portions 49 made up of the recessed portions 47 are 250 μm or less.
The widths of the linear portions 49 made up of the protruding portions 46 are 250 μm or less.
The orientations of the linear portions 49 made up of the recessed portions 47 are aligned, and are not greatly dispersed. That is to say, the orientations of the linear portions 49 made up of the recessed portions 47 included in one raised portion 43 are within an angle range of 50° or less in planar view, preferably 40° or less, more preferably 30° or less, and even more preferably 20° or less.
The orientations of the linear portions 49 made up of the protruding portions 46 are aligned, and are not greatly dispersed. That is to say, the orientations of the linear portions 49 made up of the protruding portion 46 included in one raised portion 43 are within an angle range of 50° or less in planar view, preferably 40° or less, more preferably 30° or less, and even more preferably 20° or less.
The full perimeter of at least part of the protruding portions 46 may be surrounded by the linear portions 49 made up of the recessed portions 47.
The full perimeter of at least part of the recessed portions 47 may be surrounded by the linear portions 49 made up of the protruding portions 46.
The linear portions 49 made up of the recessed portions 47 include a plurality of small segments 49S that are linear, and each of the small segments, at an end portion thereof, connects to two other small segments 49S, makes up an end portion of a linear portion 49, or is positioned at an edge of the raised portion 43.
The linear portions 49 made up of the protruding portions 46 include a plurality of small segments 49S that are linear, and each of the small segments, at an end portion thereof, connects to two other small segments 49S, makes up an end portion of a linear portion 49, or is positioned at an edge of the raised portion 43.

According to the above configuration, the uneven surface 45 of the raised portion 43 illustrated in FIG. 9 is made to be irregular, and is wood-surface-like. Thus, tactile sensation can be improved and natural features can be expressed, and the design quality of the decorative sheet 15 can be improved.

As described above, tactile sensation can be enhanced or emphasized and natural features can be realized by one of the protruding portions 46 and the recessed portions 47 making up the linear portions 49. Accordingly, the proportion of area occupied by the protruding portions 46 in one raised portion 43 may be greater than the proportion of area occupied by the recessed portions 47, or may be smaller, or may be the same. In the examples illustrated in FIG. 3 to FIG. 8, the proportion of area occupied by the protruding portions 46 in one raised portion 43 is greater than the proportion of area occupied by the recessed portions 47. In the example illustrated in FIG. 9, the proportion of area occupied by the protruding portions 46 in one raised portion 43 is smaller than the proportion of area occupied by the recessed portions 47.

The material from which the protruding portions 46 are made may be at least one type selected from two-component curing resins, thermoplastic resins, thermal curing resins, and ionizing-radiation-curing resins.

Examples of two-component-curing resins include two-component-curing urethane resins, two-component-curing epoxy resins, two-component-curing urethane-modified acrylic resins, two-component-curing polyester resins, in which a polyol compound serves as a primary agent and an isocyanate compound serves as a curing agent, and so forth.

Examples of thermoplastic resin include acrylic resins, cellulose resins, urethane resins, vinyl chloride resins, polyester resins, polyolefin resins, polycarbonate, nylon, polystyrene, ABS resins, and so forth.

Examples of thermal curing resins include acrylic resins, urethane resins, phenol resins, melamine resins, epoxy resins, unsaturated polyester resins, silicone-based resins, and so forth. A curing agent is added to thermal curing resins as necessary.

An ionizing-radiation-curing resin is a composition containing a compound that includes an ionizing-radiation-curing functional group. Examples of ionizing-radiation-curing functional groups include ethylenically unsaturated binding groups such as (meth)acryloyl groups, vinyl groups, allyl groups, and so forth, and epoxy groups, oxetanyl groups, and so forth. Ionizing-radiation-curing resin may be a compound including an ethylenically unsaturated binding group. From the perspective of suppressing damage to the resin layer in the process of manufacturing the decorative sheet, the ionizing-radiation-curing resin may be a compound having two or more ethylenically unsaturated binding groups, and preferably may be a polyfunctional (meth)acrylate compound having two or more ethylenically unsaturated binding groups. The polyfunctional (meth)acrylate compound may be a monomer or an oligomer. Ionizing radiation means electromagnetic waves and charged particle beams that have an energy quantum capable of polymerization or crosslinking of molecules. Examples of ionizing radiation include ultraviolet rays (UV) and electron beams (EB). The ionizing radiation may be an electromagnetic wave such as an X-ray or a gamma ray or may be a charged particle beam such as an alpha ray or an ion beam.

Out of polyfunctional (meth)acrylate compounds, examples of bifunctional (meth)acrylate monomers include ethylene glycol di(meth)acrylate, bisphenol A tetraethoxy diacrylate, bisphenol A tetrapropoxy diacrylate, 1,6-hexanediol diacrylate, and so forth. Examples of trifunctional or higher (meth)acrylate monomers include trimethylolpropane tri(meth)acrylate, pentaerythritol tri(meth)acrylate, pentaerythritol tetra(meth)acrylate, dipentaerythritol hexa(meth)acrylate, dipentaerythritol tetra(meth)acrylate, isocyanurate-modified tri(meth)acrylate, and so forth. Part of the molecular skeleton of the above (meth)acrylate monomers may be modified. The above (meth)acrylate monomers may be modified by ethylene oxide, propylene oxide, caprolactone, isocyanurate, alkyl, cyclic alkyl, an aromatic, bisphenol, or the like.

Examples of polyfunctional (meth)acrylate oligomers include acrylate polymers, such as urethane (meth)acrylate, epoxy (meth)acrylate, polyester (meth)acrylate, polyether (meth)acrylate, and the like. Urethane (meth)acrylate may be obtained by reaction of polyhydric alcohol and organic diisocyanate with hydroxy(meth)acrylate, for example. Epoxy (meth)acrylate may be (meth)acrylate obtained by reaction of trifunctional or higher aromatic epoxy resins, alicyclic epoxy resins, aliphatic epoxy resins, or the like, with (meth)acrylic acid, (meth)acrylate obtained by reaction of bifunctional or higher aromatic epoxy resins, alicyclic epoxy resins, aliphatic epoxy resins, or the like, with polybasic acid and (meth)acrylic acid, or (meth)acrylate obtained by reaction of bifunctional or higher aromatic epoxy resins, alicyclic epoxy resins, aliphatic epoxy resins, or the like, with phenols and (meth)acrylic acid. One type of the ionizing-radiation-curing resin may be used alone, or two or more types may be used in combination.

In a case in which the ionizing-radiation-curing resin is an ultraviolet-curing resin, the composition may include an additive such as a photopolymerization initiator and a photopolymerization promoter, or the like. In a case of a compound including an ethylenically unsaturated group, examples of the photopolymerization initiator include one type or more selected from acetophenone, benzophenone, α-hydroxyalkylphenone, Michler's ketone, benzoin, benzyl dimethyl ketal, benzoyl benzoate, α-acyl oxime ester, thioxanthones, and so forth. The photopolymerization promoter can mitigate inhibition of polymerization by air at the time of curing, and can accelerate curing. Examples of the photopolymerization promoter include one type or more selected from p-dimethyl aminobenzoic acid isoamyl ester, p-dimethyl aminobenzoic acid ethyl ester, and so forth.

The material used for the raised layer 40 may be transparent. The material used for the raised layer 40 may be colored. The material used for the raised layer 40 may be colored by adding a colorant (pigment or dye) to the composition. The colorant may be a known or commercially-available pigment or dye. One type of the colorant may be used alone, or two or more types thereof may be used together. The amount of addition of the colorant can be set as appropriate in accordance with a desired shade of color, or the like.

The composition used for fabrication of the raised layer 40 may include various types of additives, such as a filler, a delustering agent, a foaming agent, a flame retardant, a lubricant, an antistatic agent, an antioxidant, an ultraviolet absorber, a light stabilizer, a radical scavenger, a softening component (e.g., rubber), and the like.

As in the example illustrated in FIG. 3, a plurality of linear portions 49 may meander, with the orientations of the linear portions 49 being within a certain angle range. As in the example illustrated in FIG. 4, protruding portions 46 may be provided of which the full perimeter is surrounded by the recessed portions 47. Note, however, that not all of the protruding portions 46 present in the raised portion 43 need to include the full perimeter thereof surrounded by the recessed portions 47. The proportion or count of protruding portions 46 of which full perimeter is surrounded by the recessed portions 47 may be set as long as the decorative sheet 15 has a desired external appearance. A ratio of a total value ΣLS of the lengths of the recessed portions 47 surrounding the full perimeter of protruding portions 46, as to a grand total value ΣLtotal of the length of all recessed portions 47 measured along the direction (longitudinal direction) in which the recessed portions 47 present in one raised portion 43 extend, is ΣLS/ΣLtotal. From the perspectives of tactile sensation, natural features, and delustering, ΣLS/ΣLtotal≥ 3/10 is preferable, ΣLS/ΣLtotal 5/10 is more preferable, and ΣLS/ΣLtotal 7/10 is even more preferable.

(Particles Contained in Protruding Portions)

The protruding portions 46 may contain particles. According to protruding portions 46 that contain particles, tactile sensation and external appearance that are different from those of protruding portions 46 that do not contain particles. Note, however, that the protruding portions 46 do not have to contain particles.

The average particle size of the particles is not limited in particular. The average particle size of the particles is preferably smaller than the thickness of the protruding portions 46. According to this setting, the particles contained in the protruding portions 46 serve as frameworks for the protruding portion 46, thereby facilitating control of the thickness of the protruding portions 46. More specifically, the average particle size may be 5 μm or more and 100 μm or less. The average particle size of the particles can be identified by averaging measurement values obtained by performing sprayed dry measurement, in which a powder that is the object of measurement is sprayed from a nozzle using compressed air and dispersed in the air, and is measured. The average particle size of the particles is a value identified using a laser diffraction particle size distribution measurement device “SALD-2100-WJA1”, manufactured by Shimadzu Corporation.

The particles may be beads made of a resin such as acrylic resin, urethane resin, silicone resin, polyamide resin such as nylon or the like, or an inorganic material such as silica, alumina, zirconia, titania (titanium dioxide), kaolinite, calcium carbonate, barium sulfate, or the like. One of the above-described types of the particles may be used alone, or two or more types may be used together.

Note that resin particles can include a larger particle size as compared to inorganic particles. Tactile sensation can be enhanced or emphasized by the uneven surface 45 having a sufficient height difference due to using resin particles that have a large particle size. On the other hand, resin particles are highly lustrous, and do not readily blend in with the pattern of the surface of wood displayed by the design layer 30. High lustrousness due to resin particles has increased the impression of artificialness in decorative sheets having the conventional raised layer, diminishing the design quality of the decorative sheets 15.

In contrast with this conventional trouble, according to the uneven surface 45 that is irregular, and the uneven surface 45 that includes the wood-surface-like recesses and protrusions, tactile sensation can be enhanced or emphasized even without resin particles with large particle sizes. Accordingly, low-luster particles, such as inorganic particles that have a lower luster than resin particles, for example, can be used for the raised portion 43. Accordingly, in addition to enhanced tactile sensation and creation of natural features, low lustrousness can be realized. Low lustrousness further enhances or emphasizes the natural features, and the design quality of the decorative sheet 15, in particular the design quality of the decorative sheet 15 including the design layer 30 that includes the pattern of the surface of wood, can be markedly improved.

In the protruding portions 46, the contained amount of the particles preferably is 5 parts by mass or more to 60 parts by mass or less as to 100 parts by mass of the composition making up the protruding portions 46, more preferably is 5 parts by mass or more to 50 parts by mass or less, and even more preferably is 10 parts by mass or more to 40 parts by mass or less.

### Specific Examples of that which is Expressed

The raised portion 43 having the above configuration may be laid out in accordance with the pattern of the design layer 30.

In a case in which the design layer 30 includes a wood-grain pattern that includes growth ring portions, the design external appearance and the tactile sensation of the wood-grain pattern can be reproduced suitably in accordance with the layout of the raised portion 43. For example, an arrangement may be made in which the raised portion 43 is laid out only in a region being overlaid to one of a latewood (autumn wood) portion in the growth ring portions, and an earlywood (springwood) portion in the growth ring portions. Alternatively, raised portions 43 of different configurations may be laid out on the latewood (autumn wood) portion and the earlywood (springwood) portion. In a case in which the design layer 30 includes a wood-grain pattern that includes knots (knotholes), the raised portion 43 may be laid out only on a region being overlaid to one of the knots and portions other than the knots. Alternatively, raised portions 43 of different configurations may be laid out on the knots and the portions other than the knots. According to this example, recesses and protrusions similar to recesses and protrusions occurring on actual surface of wood can be reproduced by the raised layer 40.

By laying out the raised portion 43 in accordance with the pattern of the design layer 30, the effects and advantages of enhanced tactile sensation and creation of natural features by the raised layer 40 are synergistically intensified. As a result, the design quality of the decorative sheet 15, in particular the design quality of the decorative sheet 15 including the design layer 30 having the pattern of the surface of wood can be markedly improved.

As described above, the design layer 30 includes the first regions 31 and the second regions 32. In the example illustrated in FIG. 1, the first regions 31 are the light portions. The second regions 32 are the dark portions that are darker than the first regions 31. In the example illustrated in the drawing, the first regions 31 include the earlywood 33A portions. The second regions 32 include the latewood 33B portions, the knot 33C, and the duct. On the other hand, the raised layer 40 includes the raised regions 41 in which the raised portion 43 is provided, and the non-raised regions 42 in which the raised portion 43 is not provided. In the example illustrated in FIG. 2, the raised regions 41 is overlaid only to one of the first regions 31 and the second regions 32 in the z direction. More specifically, the raised regions 41 is overlaid to the first regions 31 in the z direction. The non-raised regions 42 is overlaid to the second regions 32 in the z direction. According to this example, recesses and protrusions that are similar to the pattern of the surface of wood displayed by the design layer 30 are expressed by the presence of the raised portion 43 of the raised layer 40. Further, a sense of unevenness can be expressed within the raised portion 43 due to the uneven surface 45. Thus, the pattern of the surface of wood that is displayed by the design layer 30 can be enhanced or emphasized by the raised layer 40, and the design quality of the decorative sheet 15 is effectively raised.

The raised regions 41 may be overlaid to the second regions 32, and the non-raised regions 42 may be overlaid to the first regions 31, unlike the illustrated example. Effects and advantages similar to those of the illustrated example can be obtained by this example as well.

As described above, the raised portion 43 can impart tactile sensation sensed by the sense of touch, by the edge portions thereof, and can also impart tactile sensation due to the uneven surface 45 therewithin. An arrangement may be made in which the tactile sensation obtained at the edge portions of the raised portion 43 and the tactile sensation obtained within the raised portion 43 are different from each other, anticipating effects of improved design quality from tactile sensation. With regard to this perspective, an interval (distance) 41D (see FIG. 2) between two adjacent raised regions may be larger than the width W of the linear portions 49 of the raised portion 43. The interval (distance) between two adjacent raised regions may be larger than two times the width W of the linear portions 49 of the raised portion 43, may be larger than four times, and may be larger than ten times. The interval (distance) 41D between two adjacent raised regions may be 1 mm or more, may be 5 mm or more, and may be 10 mm or more.

<Other Configurations>

### (Relation Between Substrate and Raised Layer)

In the decorative sheet 15, the substrate 20 and the raised layer 40 may be made of different materials. The raised layer 40 may be stacked to the substrate 20. In another example, the substrate 20 and the raised layer 40 may be integral. In this example, the raised layer 40 may be made on the surface of the material making up the substrate 20. Also, the substrate 20 and the raised layer 40 may be made of the same material. The substrate 20 and the raised layer 40 may be seamlessly fabricated of the same material.

(Delustering Layer)

The decorative sheet 15 may further include a delustering layer (not illustrated) stacked to the raised layer 40. The delustering layer can manifest a visual sense of unevenness by creating a luster difference (or gloss difference) as to surrounding regions. Note, however, that the delustering layer does not have to be provided. The delustering layer may be provided over the entire surface of the raised layer 40. Taking into consideration manifesting a visual sense of unevenness by creating a luster difference as to surrounding regions, the delustering layer preferably is provided at portions directly above and near the raised portion 43, and more preferably is provided limited to portions directly above the raised portion 43.

The delustering layer may contain a delustering agent, from the perspective of improving delustering effects. Examples of the delustering agent include inorganic fine particles and organic fine particles. Examples of inorganic fine particles include particles made of silica, alumina, aluminosilicate, kaolinite, calcium carbonate, barium sulfate, glass, and so forth. Examples of organic fine particles include particles made of acrylic resin, polycarbonate resin, urethane resin, urea resin, benzoguanamine resin, benzoguanamine-melamine-formaldehyde condensate, and so forth. Silica particles are suitable as a delustering agent due to having high delustering effects, and control of luster being easy. The delustering layer may contain one type of those described above alone as the delustering agent, or contain two or more types in combination. From the perspective of delustering effects and control of luster, the particle size of the delustering agent preferably is 1 μm or more and 10 μm or less, more preferably is 2 μm or more and 9 μm or less, and even more preferably is 3 μm or more and 7 μm or less.

(Backing Substrate)

The decorative sheet 15 may include a backing substrate (not illustrated) on the side of the substrate 20 that is the opposite side from the surface on which the design layer 30 is provided. The backing substrate can reinforce the decorative sheet 15. The backing substrate can improve adhesion between the decorative sheet 15 and the support member 11. The backing substrate can shield the support member 11.

Examples of the backing substrate include resin sheets, paper, non-woven cloth, woven cloth, metal foil, and so forth. Examples of the resin sheet include sheets of acrylic resin, polyester resin, polyolefin resin, polyvinyl chloride resin, ABS resin, and so forth.

Taking into consideration reinforcement, adhesion, and shielding properties, the thickness of the backing substrate may be 0.05 mm or more and 0.15 mm or less, may be 0.06 mm or more and 0.13 mm or less, or may be 0.08 mm or more and 0.12 mm or less.

(Adhesive Layer)

An adhesive layer (not illustrated) may be included between at least one of the substrate 20, the raised layer 40, the design layer 30, the delustering layer, and the backing substrate, in the decorative sheet 15. The adhesive layer has functions of assisting bonding between the layers of the substrate 20, the raised layer 40, the design layer 30, the delustering layer, and the backing substrate, and can strengthen bonding between the layers. The adhesive layer may be at least one selected from two-component curing resins, thermoplastic resins, thermal curing resins, and ionizing-radiation-curing resins.

(Primer Layer)

A primer layer (not illustrated) may be included between at least one of the substrate 20, the raised layer 40, the design layer 30, the delustering layer, and the backing substrate, in the decorative sheet 15. The primer layer has functions of assisting bonding between the layers of the substrate 20, the raised layer 40, the design layer 30, the delustering layer, and the backing substrate, and can strengthen bonding between the layers. The material of the primer layer is not limited in particular. The material of the primer layer may be a resin that improves close contact of both layers facing each other across the primer layer that is interposed therebetween.

[Manufacturing of Decorative Material]

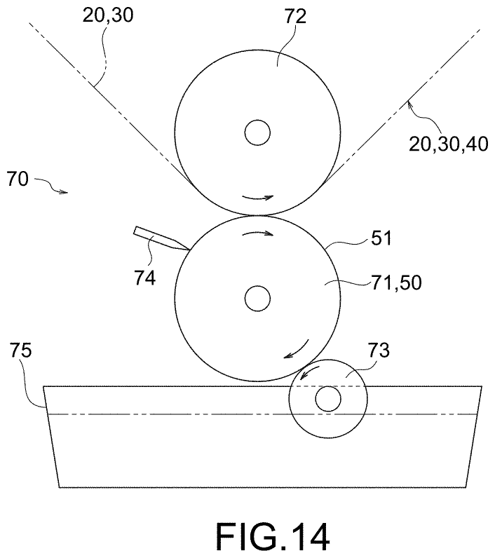

The design layer 30 can be fabricated on the substrate 20 by printing or transferring. The raised layer 40 can be fabricated on the substrate 20 using a plate 50, as illustrated in FIG. 14. The decorative sheet 15 illustrated in FIG. 11 is obtained by fabricating the design layer 30 and the raised layer 40 in that order on the substrate 20.

In the example illustrated in FIG. 14, the raised layer 40 is fabricated using a raised layer fabricating device 70. The raised layer fabricating device 70 includes a plate roll 71, a backup roll 72, a supply roll 73, a squeegee 74, and an ink pan 75. In this example, the raised layer fabricating device 70 is a gravure printer. The plate 50 makes up the plate roll 71 to serve as a gravure printing plate. The above-described composition that will form the raised layer 40 is held in the ink pan 75. The supply roll 73 is partially immersed in the composition in the ink pan 75. An outer circumferential surface of the supply roll 73 is in contact with an outer circumferential surface of the plate roll 71. The composition in the ink pan 75 is supplied to the plate roll 71 by the supply roll 73 and the plate roll 71 rotating. The composition supplied to the outer circumferential surface of the plate roll 71 is scraped away as appropriate by the squeegee 74. The substrate 20 is supplied between the plate roll 71 and the backup roll 72. The composition is printed on the substrate 20 passing between the plate roll 71 and the backup roll 72. In a case of fabricating the decorative sheet 15 illustrated in FIG. 11, the substrate 20 having the design layer 30 thereon is supplied to the raised layer fabricating device 70. The composition is printed on the design layer 30. The composition on the substrate 20 is cured by being irradiated by ionizing radiation, for example. The raised layer 40 is fabricated from the composition that is cured.

The plate 50 that functions as the plate roll 71 includes a plate surface 51. The supply roll 73 supplies the composition serving as ink to the plate surface 51. The squeegee 74 scrapes excess composition away from the plate surface 51.

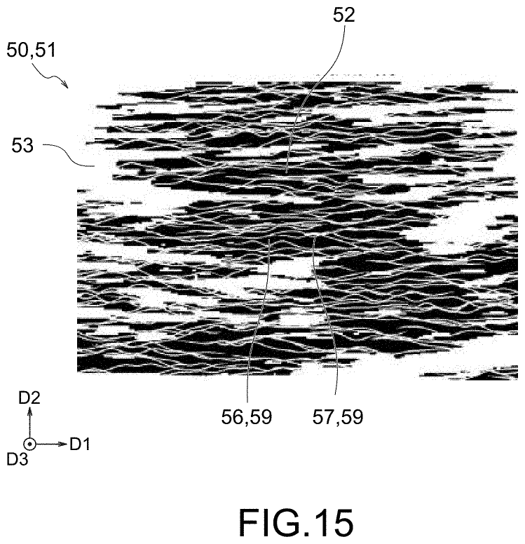

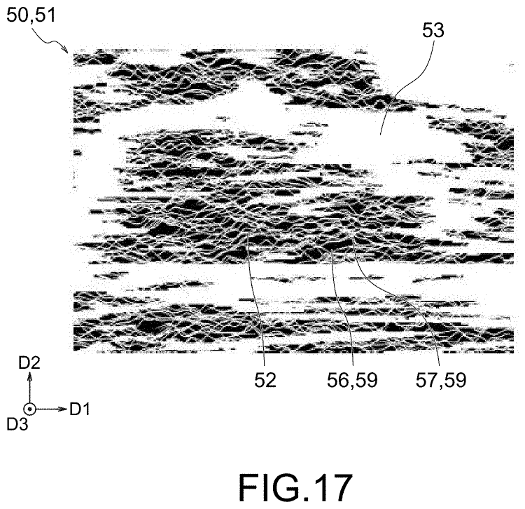

FIG. 15 to FIG. 20 illustrate several examples of the plate surface 51. FIG. 15 to FIG. 20 illustrate the plate surface 51 that is cylindrical having been flatly developed. The plate surface 51 includes a plate flat surface 53 that is flat, and a plate uneven surface 52 that includes recesses and protrusions. The composition on the plate flat surface 53 is scraped away by the squeegee 74. The plate uneven surface 52 includes depressions 56 that are also referred to as cells, and banks 57 that are positioned between the depressions 56. The banks 57 are positioned flush with the plate flat surface 53. Accordingly, the composition upon the banks 57 is scraped away by the squeegee 74. The depressions 56 are recessed in comparison with the banks 57 and the plate flat surface 53. The composition serving as the ink that is accommodated in the depressions 56 is transferred onto the substrate 20. In a case of using the plate 50, regions of the substrate 20 that face the plate flat surface 53 become the non-raised regions 42. The regions of the substrate 20 that face the plate uneven surface 52 become the raised regions 41. The protruding portions 46 of the raised portion 43 are formed at positions of the substrate 20 facing the depressions 56 of the plate uneven surface 52. The recessed portions 47 of the raised portion 43 are formed at portions of the substrate 20 facing the banks 57 of the plate uneven surface 52. Note that the protruding portions 46 can be formed at part of portions facing the bank 57, depending on leveling of the composition. Also, there are cases in which the protruding portions 46 are not formed at part of portions facing the depression 56, depending on transfer efficiency of the composition.

In FIG. 15 to FIG. 20, the banks 57 are represented by white, and the depressions 56 by black or gray, to facilitate understanding. In an actual plate 50, the banks 57 and the depressions 56 do not have to be color coded.

In order to fabricate the raised portion 43 having the above-described configuration, the plate surface 51 includes a configuration corresponding to the raised portion 43, a configuration that is complementary to the raised portion 43. At least one of the depressions 56 and the banks 57 include linear elements 59 of which at least one of the orientations and the lengths are not constant. The linear elements 59 form the linear portions 49.

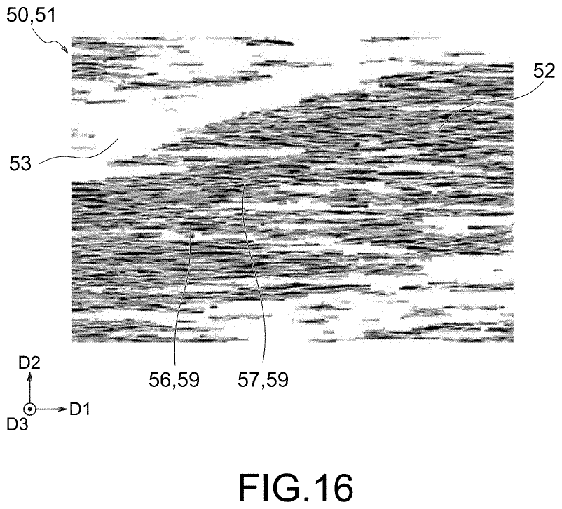

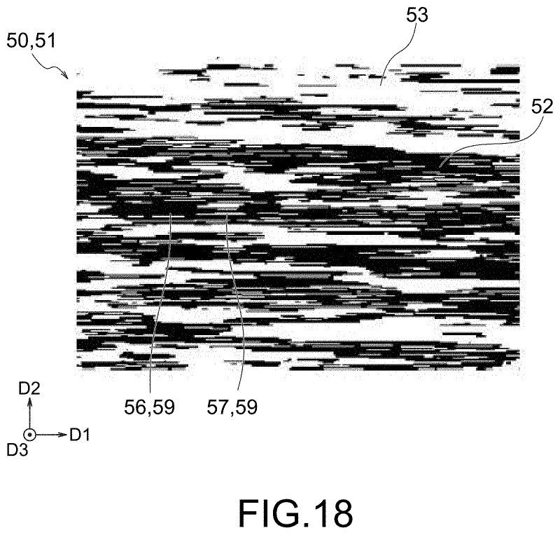

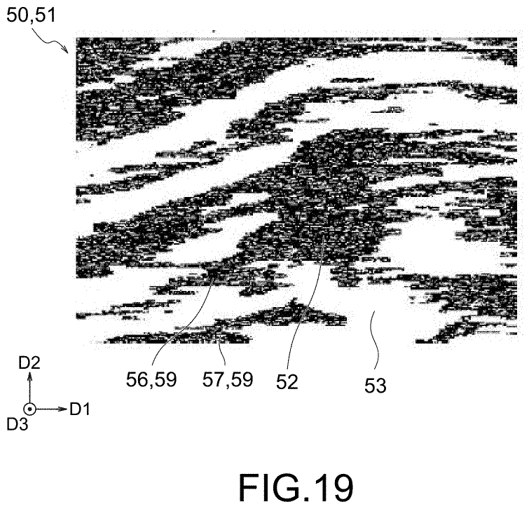

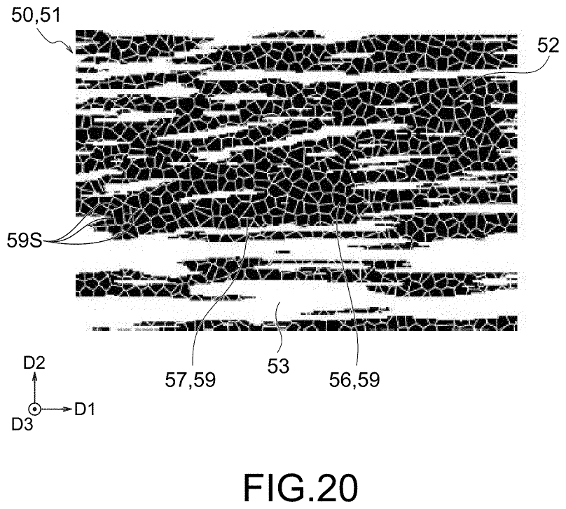

According to the plate 50 illustrated in FIG. 16, the raised layer 40 including the raised portion 43, which is illustrated in FIG. 5, can be fabricated. According to the plate 50 illustrated in FIG. 18, the raised layer 40 including the raised portion 43, which is illustrated in FIG. 6, can be fabricated. According to the plate 50 illustrated in FIG. 19, the raised layer 40 including the raised portion 43, which is illustrated in FIG. 7, can be fabricated. According to the plate 50 illustrated in FIG. 20, the raised layer 40 including the raised portion 43, which is illustrated in FIG. 8, can be fabricated.

The plates 50 illustrated in FIG. 15 to FIG. 17 may include the following configuration.
The linear elements 59 made up of the depressions 56 include curved-line shapes.
The linear elements 59 made up of the banks 57 include curved-line shapes.
The lengths of the linear elements 59 made up of the depressions 56 are not constant.
The lengths of the linear elements 59 made up of the banks 57 are not constant.
The widths of the linear elements 59 made up of the depressions 56 are 250 μm or less.
The widths of the linear elements 59 made up of the banks 57 are 250 μm or less.
Orientations of the linear elements 59 made up of the depressions 56 are aligned, and are not greatly dispersed. The orientations of the linear elements 59 made up of the depressions 56 included in one plate uneven surface 52 are, in the developed planar view of the plate surface 51 that is cylindrical, within an angle range of 50° or less, preferably 40° or less, more preferably 30° or less, and even more preferably 20° or less.
The orientations of the linear elements 59 made up of the banks 57 are aligned, and are not greatly dispersed. The orientations of the linear elements 59 made up of the banks 57 included in one plate uneven surface 52 are, in the developed planar view of the plate surface 51 that is cylindrical, within an angle range of 50° or less, preferably 40° or less, more preferably 30° or less, and even more preferably 20° or less.
The full perimeter of at least part of the banks 57 is surrounded by the linear elements 59 made up of the depressions 56.
The full perimeter of at least part of the depressions 56 is surrounded by the linear elements 59 made up of the banks 57.
The linear elements 59 made up of the banks 57 include a plurality of small segments that are linear, and each of the small segments, at an end portion thereof, connects to two other small segments, makes up an end portion of a linear element 59, or is positioned at an edge of the plate uneven surface 52.
The linear elements 59 made up of the depressions 56 include a plurality of small segments that are linear, and each of the small segments, at an end portion thereof, connects to two other small segments, makes up an end portion of a linear element 59, or is positioned at an edge of the plate uneven surface 52.

The plate 50 illustrated in FIG. 18 may have the following configuration.
The linear elements 59 made up of the banks 57 include straight-line shapes, and the lengths of the linear elements 59 are not constant.
The widths of the linear elements 59 made up of the banks 57 are 250 μm or less. The lengths of the linear elements 59 made up of the banks 57 are 100 μm or more and 1000 μm or less.
At least part of the linear elements 59 made up of the banks 57 include one end portion or both end portions positioned inside the plate uneven surface 52.
The orientations of the linear elements 59 made up of the banks 57 are aligned, and are not greatly dispersed. The orientations of the linear elements 59 made up of the banks 57 included in one plate uneven surface 52 are, in the developed planar view of the printing area 51 that is cylindrical, within an angle range of 50° or less, preferably 40° or less, more preferably 30° or less, and even more preferably 20° or less.

The plate 50 illustrated in FIG. 19 may have the following configuration.
The linear elements 59 made up of the banks 57 include curved-line shapes.
The lengths of the linear elements 59 made up of the banks 57 are not constant.
The widths of the linear elements 59 made up of the banks 57 are 250 μm or less.
The lengths of the linear elements 59 made up of the banks 57 are 20 μm or more and 250 μm or less.
At least part of the linear elements 59 made up of the banks 57 may include one end portion or both end portions positioned inside the plate uneven surface 52.
The orientations of the linear elements 59 made up of the banks 57 are aligned, and are not greatly dispersed. The orientations of the linear elements 59 made up of the banks 57 included in one plate uneven surface 52 are, in the developed planar view of the printing area 51 that is cylindrical, within an angle range of 50° or less, preferably 40° or less, more preferably 30° or less, and even more preferably 20° or less.

The plate 50 illustrated in FIG. 20 may have the following configuration.
The linear elements 59 made up of the banks 57 include curved-line shapes.
The lengths of the linear elements 59 made up of the banks 57 are not constant.
The widths of the linear elements 59 made up of the banks 57 are 250 μm or less.
The orientations of the linear elements 59 made up of the banks 57 are greatly dispersed.
The orientations of any two linear elements 59 (small segments 59S) included in one plate uneven surface 52 are, in the developed planar view of the printing area 51 that is cylindrical, inclined by 70° or more at most, preferably inclined by 80° or more, and more preferably inclined by 90°.
The full perimeter of at least part of the depressions 56 is surrounded by the linear elements 59 made up of the banks 57.
The linear elements 59 made up of the banks 57 include a plurality of small segments 59S that are linear, and each of the small segments 59S, at an end portion thereof, connects to two other small segments 59S, makes up an end portion of a linear element 59, or is positioned at an edge of the plate uneven surface 52.

Note that the small segments 59S (see FIG. 20) relating to the linear elements 59 are obtained by dividing the linear elements 59 at branch points and intersection points, in the same way as the small segments 49S relating to the linear portions 49 described above. The small segments 59S of the linear elements 59 are linear portions extending between both ends thereof, and connect to a plurality of other small segments 59S of the linear elements 59 at the end portions only. The linear elements 59 can also be said to be a collection of the small segments 59S. In a case in which the linear elements 59 are configured in a mesh-like form as in FIG. 20, for example, the linear elements 59 include a plurality of small segments 59S that are linear. Each small segment 59S, at an end portion thereof, connects to a plurality of other small segments 59S, makes up an end portion of the linear element 59, or is positioned at an edge of the plate uneven surface 52.

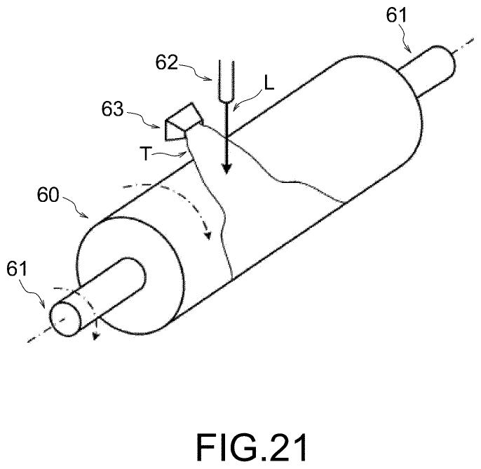

The plate 50 that serves as a gravure printing plate can be manufactured by engraving, as illustrated in FIG. 21.

In the example illustrated in FIG. 21, the depressions 56 are formed in a surface of a metal roll 60 by irradiation by a laser beam L from a laser head 62 to the surface of the metal roll 60. The metal roll 60 is rotationally drive by a rotational drive shaft 61 while being engraved by the laser beam L. Thus, depressions 56 can be formed at desired positions on an outer circumferential surface of the metal roll 60. While engraving is being performed by the laser beam L, an engraving liquid T is sprayed on the surface of the metal roll 60 from an engraving liquid discharge port 63. Using the engraving liquid T suppresses evaporated metal from becoming powder and remaining on or adhering to the surface of the metal roll 60. After engraving using the laser beam L, the metal roll 60 is cleansed and the engraving liquid T is removed. Next, residual metal adhering to the surface of the metal roll 60 is removed by electrolytic polishing. Subsequently, a chromium layer is formed by plating on the surface of the metal roll 60 to a thickness of 10 μm. According to the above, the plate 50, in particular the gravure printing plate roll 71, is obtained.

Although the plate 50 is used as a gravure printing plate at the time of forming the raised layer 40 on the substrate 20, this example is not restrictive. The raised layer 40 may be formed by embossing, using the plate 50 as an embossing plate.

An embodiment of the present disclosure relates to the following [1] to [29] and [A] to [E].
[1] A decorative sheet includes
   a design layer that includes a pattern of a surface of wood, and
   a raised layer that is stacked to the design layer, wherein
   the raised layer includes a raised portion provided in a raised region that is overlaid to part of the design layer, and
   the raised portion includes an uneven surface like the surface of wood.
[2] The decorative sheet according to [1], wherein the raised portion includes a shape and a layout that reproduce the surface of wood.
[3] The decorative sheet according to [1] or [2], wherein
   the design layer includes a first region, and a second region other than the first region,
   a density of the pattern in the first region is lower than a density of the pattern in the second region, and
   the raised region is overlaid only to one of the first region and the second region.
[4] The decorative sheet according to [3], wherein the pattern in the second region includes one or more of a duct, a knot, and latewood.
[5] The decorative sheet according to any one of [1] to [4], wherein
   the uneven surface includes protruding portions and recessed portions, and
   at least one of the protruding portions and the recessed portions include linear portions of which at least one of an orientations and a lengths are not constant.
[6] A decorative sheet includes
   a design layer that includes a pattern of a surface of wood, and
   a raised layer that is stacked to the design layer, wherein
   the raised layer includes a raised portion provided in a raised region that is overlaid to part of the design layer, and
   the raised portion includes an uneven surface that is irregular.
[7] A decorative sheet includes
   a design layer that includes a pattern of a surface of wood, and
   a raised layer that is stacked to the design layer, wherein
   the raised layer includes a raised portion provided in a raised region that is overlaid to part of the design layer,
   the raised portion includes an uneven surface that includes protruding portions and recessed portions, and
   at least one of the protruding portions and the recessed portions include linear portions of which at least one of orientations and lengths are not constant.
[8] The decorative sheet according to any one of [5] to [7], wherein widths of the linear portion are 250 μm or less.
[9] The decorative sheet according to any one of [5] to [8], wherein the raised region includes raised regions, and an interval between two adjacent raised regions is 1 mm or more.
[10] The decorative sheet according to any one of [5] to [9], wherein the linear portions include curved-line shapes.
[11] The decorative sheet according to [10], wherein the linear portions that are one of the protruding portions and the recessed portions surround a full perimeter of at least part of another of the protruding portions and the recessed portions.
[12] The decorative sheet according to any one of [5] to [9], wherein the linear portions include straight-line shapes.
[13] The decorative sheet according to [5] to [12], wherein at least a part of the linear portions includes one end portion or both end portions positioned inside the raised portion.
[14] The decorative sheet according to any one of [5] to [13], wherein the orientations of the linear portions included in the raised portion are within an angle range of 50° or less, preferably 40° or less, more preferably 30° or less, and even more preferably 20° or less.
[15] The decorative sheet according to any one of [5] to [13], wherein the orientations of two linear portions included in the raised portion are inclined by 70° or more at most, preferably 80° or more, and more preferably 90°.
[16] The decorative sheet according to [15], wherein
   each of the linear portions includes small segments that are linear, and
   at an end portion thereof, each of the small segments connects to other small segments, makes up an end portion of the linear portions, or is positioned at an edge of the raised portion.
[17] A decorative material, including
   the decorative sheet according to any one of [1] to [16]; and
   a support member that supports the decorative sheet.
[18] A plate used in forming a raised layer of a decorative sheet, the plate including
   a plate surface including a plate flat surface that is flat and a plate uneven surface that includes recesses and protrusions, wherein
   the plate uneven surface includes depressions, and banks including flat surfaces that are positioned between the depressions, and
   at least one of the depressions and the banks include linear elements of which at least one of orientations and lengths are not constant.
[19] A plate used in forming a raised layer of a decorative sheet, the plate including
   a plate surface including a plate flat surface that is flat and a plate uneven surface that includes recesses and protrusions that are irregular, wherein
   the plate uneven surface includes depressions, and banks including flat surfaces that are positioned between the depressions.
[20] The plate according to [18] or [19], wherein widths of the linear element are 250 μm or less.
[21] The plate according to any one of [18] to [20], wherein an interval between two adjacent plate uneven surfaces is 1 mm or more.
[22] The plate according to any one of [18] to [21], wherein the linear elements include curved-line shapes.
[23] The plate according to any one of [18] to [22], wherein the linear elements that are one of the depressions and the banks surrounds a full perimeter of at least part of another of the depressions and the banks.
[24] The plate according to any one of [18] to [21], wherein the linear elements include straight-line shapes.
[25] The plate according to any one of [18] to [24], wherein at least part of the linear elements includes one end portion or both end portions positioned inside the plate uneven surface.
[26] The plate according to any one of [18] to [25], wherein the orientations of the linear elements included in the plate uneven surface are within an angle range of 50° or less.
[27] The plate according to any one of [18] to [25], wherein the orientations of two linear elements included in the plate uneven surface are inclined by 70° or more at most, preferably 80° or more, and more preferably 90°.
[28] The plate according to any one of [18] to [27], wherein
   the linear elements include small segments that are linear, and
   at an end portion thereof, each of the small segments connects to other small segments, makes up an end portion of the linear element, or is positioned at an edge of the plate uneven surface.
[29] A method of manufacturing a decorative sheet, the method comprising:
   forming a design layer; and
   forming a raised portion using the plate according to any one of [18] to [27], thereby forming a raised layer including the raised portion, wherein
   the raised portion is positioned in a raised region that is overlaid to part of the design layer.
[A] A decorative sheet that includes recesses and protrusions on a surface thereof,
   the decorative sheet including recessed portions that are linear and that extend in a meandering manner in planar view, wherein
   the recessed portions that are adjacent in planar view come into contact, protruding portions are formed that are surrounded by the recessed portions that are adjacent, and a layout of the protruding portions is irregular.
[B] The decorative sheet according to [A], wherein the recessed portions and the protruding portions include a shape and a layout reproducing a wood-grain pattern.
[C] The decorative sheet according to [B], further including a motif layer having a motif of wood grain.
[D] The decorative sheet according to [A], wherein the recessed portions and the protruding portions include a shape and a layout reproducing a cloth pattern.
[E] The decorative sheet according to [D], further including a motif layer having a motif of cloth.

### EXAMPLES

Next, the present disclosure will be described in further detail by way of an Example. Note, however, that the present disclosure is not limited by this Example.

### Example 1

The decorative sheet illustrated in FIG. 1 was fabricated as an Example. The decorative sheet had the layer configuration illustrated in FIG. 11. That is to say, the decorative sheet included the substrate, the design layer, and the raised layer in this order. The substrate was paper 45 g/m2 thick. The design layer was the layer having the wood-grain pattern illustrated in FIG. 1. The design layer was formed on the substrate by printing. The design layer included the first regions corresponding to the light portions of the wood-grain pattern, and the second regions corresponding to the dark portions of the wood-grain pattern. The first region included the earlywood portion of the growth rings in the wood-grain pattern. The second region included the latewood portions of the growth rings, and the knot, in the wood-grain pattern. The raised layer was formed on the design layer by gravure printing using the gravure printing plate. The raised layer included the raised regions at positions that are overlaid on the first regions of the design layer, and included the non-raised regions at positions that are overlaid on the second regions of the design layer, as illustrated in FIG. 2. The raised portion was provided only on the raised region. The raised portion was not provided in the non-raised regions. The composition used in formation of the raised portion contained 100 parts by mass of acrylic polyol resin and 27 parts by mass of silica. The average particle size of the silica was 12 μm.

The plate used for forming the raised layer included the printing area illustrated in FIG. 16. The raised portion of the raised layer that was formed included the uneven surface illustrated in FIG. 3 and FIG. 5. In the raised layer of the decorative sheet according to the Example, the raised portion included an uneven surface that was irregular. The raised portion included a wood-grain-like uneven surface. The recessed portions of the uneven surface were linear portions of which both the orientations and the lengths were not constant. The protruding portions of the uneven surface were linear portions of which both the orientations and the lengths were not constant. The uneven surface of the raised portion included a plurality of protruding portions of which the full perimeters were surrounded by recessed portions, as indicated by the protruding portion D in FIG. 4. There was no regularity in the layout of these plurality of protruding portions, and the areas thereof in planar view also differed. More specifically, the dimensions of the protruding portions in the x direction were distributed in a range of 95 μm or more and 290 μm or less. The dimensions of the protruding portions in the y direction were distributed in a range of 420 μm or more and 7600 μm or less.

### Comparative Example 1

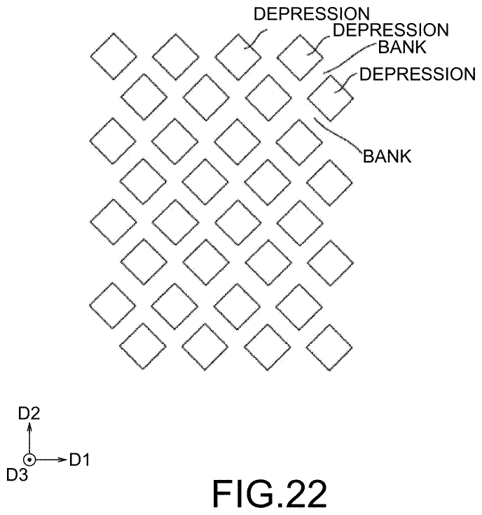

Comparative Example 1 differed from the Example with respect to the configuration of the printing area of the plate used for forming the raised layer. Other than this, Comparative Example 1 was manufactured by the same manufacturing method, using the same material as the Example. In Comparative Example 1, the plate used for forming the raised layer included the printing area illustrated in FIG. 22. The plate illustrated in FIG. 22 was a conventional plate, and included depressions that were rhombic in planar view in a regular array. The depressions that were rhombic in planar view were arrayed at a constant pitch in two directions that were orthogonal. In the decorative sheet according to Comparative Example 1, the raised portion included protruding portions laid out in a regular manner in an xy plane. The composition of which the protruding portions were made was the same as in the Example. The dimensions of the protruding portions in the x direction and the dimensions of the protruding portions in the y direction were both 240 μm. The shapes in planar view of the protruding portions were substantially square. The distance (interval) between the protruding portions was 1000 μm. In the same way as in Example 1, the raised portion was positioned so as to be overlaid on the first region that serves as the light portion in the wood-grain pattern expressed by the design layer.

### Comparative Example 2

Comparative Example 2 differed from Comparative Example 1 with respect to the composition used for forming the raised layer. Other than that, Comparative Example 2 was manufactured by the same manufacturing method as Comparative Example 1. In Comparative Example 2, the plate used for forming the raised layer included the printing area illustrated in FIG. 22, in the same way as with Comparative Example 1. Accordingly, the raised layer of Comparative Example 2 was the same as the raised layer of Comparative Example 1 regarding dimensions and shape in planar view. The composition used in Comparative Example 2 differed from the composition used in Comparative Example 1, in that the average particle size of the particles was 30 μm. Also, the composition used in Comparative Example 2 differed from the composition used in Comparative Example 1, with respect to the point of containing 37 parts by mass of the particles as to 100 parts by mass of the acrylic polyol resin. Other than that, the composition used in Comparative Example 2 was the same as the composition used in Comparative Example 1. In the same way as in Example 1, the raised portion was positioned so as to be overlaid on the first region that serves as the light portion in the wood-grain pattern expressed by the design layer.

[Tactile Sensation and External Appearance]

Twenty adults were made to perform checking of the surface of the decorative material fabricated in the Example and the Comparative Examples by touching with fingers, and evaluation was made according to the following standard.
Good: ten or more people answered that the tactile sensation and external appearance are like those of an actual wood-grain surface
Poor: less than ten people answered that the tactile sensation and external appearance are like those of an actual wood-grain surface

[Results]

The following results were obtained regarding tactile sensation and external appearance.

The Example was “Good”, and was evaluated that luster was suppressed and the external appearance and tactile sensation were natural for a wood-grain pattern.

Comparative Example 1 was “Poor”, and was evaluated that luster was suppressed but both the external appearance and tactile sensation were artificial.

Comparative Example 2 was “Poor”0, and was evaluated that tactile sensation was good, but luster was particularly high regarding the external appearance, and was unnatural for a wood-grain pattern.

### REFERENCE SIGNS LIST

10 decorative material
11 support
15 decorative sheet
20 substrate
30 design layer
31 first region
32 second region
33A earlywood
33B latewood
33C knot
40 raised layer
41 raised region
42 non-raised region
43 raised portion
45 uneven surface
46 protruding portion
47 recessed portion
49, 49A linear portion
49S small segment
50 plate
51 plate surface
52 plate uneven surface
53 plate flat surface
56 depression
57 bank
59 linear element

1. A decorative sheet, comprising:
a design layer that includes a pattern of a surface of wood; and
a raised layer that is stacked to the design layer,
wherein the raised layer includes a raised portion provided in a raised region that is overlaid to part of the design layer, and
the raised portion includes an uneven surface like the surface of wood.

2. The decorative sheet according to claim 1, wherein the raised portion includes a shape and a layout that reproduce the surface of wood.

3. The decorative sheet according to claim 1,
wherein the design layer includes a first region, and a second region other than the first region,
a density of the pattern in the first region is lower than a density of the pattern in the second region, and
the raised region is overlaid only to one of the first region and the second region.

4. The decorative sheet according to claim 3, wherein the pattern in the second region includes one or more of a duct, a knot, and latewood.

5. The decorative sheet according to claim 1,
wherein the uneven surface includes protruding portions and recessed portions, and
at least one of the protruding portions and the recessed portions include linear portions of which at least one of orientations and lengths are not constant.

6. The decorative sheet according to claim 5, wherein widths of the linear portions are 250 μm or less.

7. The decorative sheet according to claim 5, wherein the raised region includes raised regions, and an interval between two adjacent raised regions is 1 mm or more.

8. The decorative sheet according to claim 5, wherein the linear portions include curved-line shapes.

9. The decorative sheet according to claim 8, wherein the linear portions that are one of the protruding portions and the recessed portions surround a full perimeter of at least part of another of the protruding portions and the recessed portions.

10. The decorative sheet according to claim 5, wherein the linear portions include straight-line shapes.

11. The decorative sheet according to claim 5, wherein at least a part of the linear portions includes one end portion or both end portions positioned inside the raised portion.

12. The decorative sheet according to claim 5, wherein the orientations of the linear portions included in the raised portion are within an angle range of 50° or less.

13. The decorative sheet according to claim 5, wherein the orientations of two linear portions included in the raised portion are inclined by 70° or more at most.

14. The decorative sheet according to claim 13,
wherein each of the linear portion includes small segments that are linear, and
at an end portion thereof, each of the small segments connects to other small segments, makes up an end portion of the linear portion, or is positioned at an edge of the raised portion.

15. A decorative material, comprising:
the decorative sheet according to claim 1; and
a support member that supports the decorative sheet.

16. A plate used in forming a raised layer of a decorative sheet, the plate comprising:
a plate surface including a plate flat surface that is flat and a plate uneven surface that includes recesses and protrusions,
wherein the plate uneven surface includes depressions, and banks including flat surfaces that are positioned between the depressions, and
at least one of the depressions and the banks include linear elements of which at least one of orientations and lengths are not constant.

17. A method of manufacturing a decorative sheet, the method comprising:
forming a design layer; and
forming a raised portion using the plate according to claim 16, thereby forming a raised layer including the raised portion,
wherein the raised portion is positioned in a raised region that is overlaid to part of the design layer.
